(19) United States
(12) Patent Application Publication
(10) Pub. No.: US 2024/0154786 A1
(43) Pub. Date: May 9, 2024

(54) ENCRYPTION PROCESSING APPARATUS AND ENCRYPTION PROCESSING METHOD

(71) Applicant: AXELL CORPORATION, Tokyo (JP)

(72) Inventors: Yusuke HOSHIZUKI, Tokyo (JP); Kotaro MATSUOKA, Tokyo (JP)

(73) Assignee: AXELL CORPORATION, Tokyo (JP)

(21) Appl. No.: 18/539,178

(22) Filed: Dec. 13, 2023

Related U.S. Application Data
(63) Continuation of application No. PCT/JP2022/013632, filed on Mar. 23, 2022.

(30) Foreign Application Priority Data
Jun. 24, 2021 (JP) 2021-104977
Aug. 12, 2021 (JP) 2021-131702

(51) Int. Cl. H04L 9/00; H04L 9/06

(52) U.S. Cl. CPC H04L 9/008; H04L 9/0618

(57) ABSTRACT

An encryption processing apparatus that processes a ciphertext, the apparatus including a processor that executes a process including: performing a homomorphic operation related to a predetermined operation for three or more of the ciphertexts for which an error range is set to make a range of an error added to a plaintext after the homomorphic operation fall within a predetermined value; and calculating a new ciphertext by applying a predetermined polynomial to a ciphertext that is a result of the homomorphic operation, wherein the calculation includes factorizing each of a plurality of the polynomials into a common polynomial common to the polynomials and an uncommon polynomial not common to the polynomials, and calculating a plurality of the new ciphertexts by using a plurality of ciphertexts calculated by applying the common polynomial to the result of homomorphic operation, and using the uncommon polynomial.

### RELATED APPLICATIONS

This application is a continuation application of and claims priority to International Application No. PCT/JP2022/013632 filed on Mar. 23, 2022, entitled Encryption Processing Device, Encryption Processing Method, and Encryption Processing Program, which claims priority to Japanese Application No. 2021-104977 filed Jun. 24, 2021, and Japanese Application No. 2021-131702 filed Aug. 12, 2021, all of which are incorporated herein by reference in their entireties.

### FIELD OF THE INVENTION

The embodiments discussed herein are related to an encryption processing apparatus that processes a ciphertext and an encryption processing method.

### BACKGROUND OF THE INVENTION

Homomorphic encryption is an encryption technique that can process encrypted data without decrypting the encrypted data.

Encryption that allows an operation between ciphertexts, corresponding to addition of plaintexts, to be performed is additive homomorphic encryption, and encryption that allows an operation between ciphertexts, corresponding to multiplication of plaintexts, to be performed is multiplicative homomorphic encryption.

There are known an additive homomorphic encryption that performs only an additive operation (addition and subtraction) while a finite cyclic group is regarded as an integer, and multiplicative homomorphic encryption that performs only a multiplicative operation (multiplication) while a finite cyclic group is regarded as an integer.

Since the finite cyclic group can be multiplied by an integer by repeating addition, a plaintext can be multiplied by an integer, and the plaintext can be exponentiated by repeating multiplication.

There is also known fully homomorphic encryption (FHE) that allows both an additive operation and a multiplicative operation to be performed while ciphertexts remain encrypted.

One of known fully homomorphic encryption techniques is fully homomorphic encryption based on the LWE (Learning with Errors) problem, which is configured by adding a small error to a plaintext in an encryption process to such an extent that there is no problem in decryption.

In fully homomorphic encryption based on the LWE problem, an error is accumulated as an operation is performed, and therefore bootstrapping for reducing an error component while the error component remains encrypted is performed before the error becomes too large to be decrypted.

The computation time of bootstrapping occupies most of the computation time included in fully homomorphic encryption. Further, the amount of computation is large in bootstrapping, because bootstrapping handles a large amount of data. Therefore, an operation of fully homomorphic encryption may not be able to obtain the operation result within a practical time.

A method for drastically improving this problem is TFHE (Fast Fully Homomorphic Encryption over the Torus) described in FHE: Fast Fully Homomorphic Encryption over the Torus. Journal of Cryptology, 33:34-91, 2020, I. Chillotti, N. Gama, M. Georgieva, and M. Izabachene (referred to as “Chillotti et al., 2020” in the following descriptions).

Homomorphic encryption includes Bit-wise type homomorphic encryption having two values as a plaintext and based on a logical operation, and Integer-wise type homomorphic encryption having an integer as a plaintext as one ciphertext. TFHE described in Chillotti et al., 2020 is the Bit-wise type.

In Bit-wise type homomorphic encryption, it is necessary to process 32 ciphertexts in order to handle, for example, a 32-bit integer because one ciphertext can only have 1 bit of information.

Addition, subtraction, multiplication, and comparison between integers are frequently used in various data processing. In a case of using a ciphertext having 1 bit of information, an operation is performed with a concept for designing a logic circuit. In addition and subtraction of 32-bit integers, one half adder and 31 full adders are used. In multiplication, full adders the number of which is near 32 squared (1024) are used.

Therefore, in order to reduce the processing time of fully homomorphic encryption and further improve the efficiency, it is necessary to enhance the speed of an operation by a full adder including bootstrapping.

### SUMMARY OF THE INVENTION

According to an aspect of the embodiments, an encryption processing apparatus processes a ciphertext, the ciphertext being a fully homomorphic cyphertext that has as a plaintext either one of two values, the value being obtained by adding an error with a predetermined variance to a predetermined value corresponding to a symbol 0 or 1, and that is able to be subjected to a logical operation without being decrypted. The encryption processing apparatus includes a processor that executes the following process. The processor performs a homomorphic operation related to a predetermined operation for three or more of the ciphertexts for which an error range is set to make a range of an error added to a plaintext after the homomorphic operation fall within a predetermined value. The processor also calculates a new ciphertext by applying a predetermined polynomial to a ciphertext that is a result of the homomorphic operation. The calculation factorizes each of a plurality of the polynomials into a common polynomial common to the polynomials and an uncommon polynomial not common to the polynomials, and calculates a plurality of the new ciphertexts by using a plurality of ciphertexts obtained by calculation applying the common polynomial to the result of homomorphic operation, and the uncommon polynomial.

The objects and advantages of the invention will be realized and achieved by the elements and combinations specifically pointed out in the claims.

It is to be understood that both the foregoing general description and the following detailed description are exemplary and illustrative and are not intended to limit the invention as claimed.

### BRIEF DESCRIPTION OF DRAWINGS

FIG. 1 is an explanatory diagram of a configuration of a full adder circuit configured by a minimum number of logical operation elements;

FIG. 2 is an explanatory diagram of a functional configuration of an encryption processing apparatus of the present embodiment;

FIG. 3 is a detailed explanatory diagram of an operation process by a full adder based on the functional configuration in FIG. 2 (Part 1);

FIG. 4 is a detailed explanatory diagram of an operation process by the full adder based on the functional configuration in FIG. 2 (Part 2);

FIG. 5 is an image diagram for explaining a circle group that TLWE encryption has as a plaintext;

FIG. 6 is an operation image diagram of binary Gate Bootstrapping;

FIG. 7 is a flowchart for explaining a processing flow of an operation process by the full adder performed by an encryption processing apparatus (Part 1);

FIG. 8 is a flowchart for explaining a processing flow of an operation process by the full adder performed by an encryption processing apparatus (Part 2);

FIG. 9 is a diagram illustrating a configuration example of an AOI gate;

FIG. 10 is a diagram illustrating a configuration example of an OAI gate;

FIG. 11 is an explanatory diagram of a functional configuration of an encryption processing apparatus that implements an AOI gate and an OAI gate;

FIG. 12 is a diagram for explaining operation processes of an AOI gate and an OAI gate based on the functional configuration in FIG. 11 in detail;

FIG. 13 is a flowchart for explaining a flow of operation processes of an AOI gate and an OAI gate performed by the encryption processing apparatus;

FIGS. 14A and 14B are diagrams illustrating ciphertexts input to and output from Gate Bootstrapping in the present embodiment; and

FIG. 15 is a block diagram illustrating an example of a computer apparatus.

### DETAILED DESCRIPTION OF EMBODIMENTS

Embodiments of the present invention are described below in detail with reference to the drawings.

In the following descriptions, an alphanumeric character sandwiched by [ ] indicates that it is a vector. An alphanumeric character sandwiched by { } indicates that it is a set.

Further, in the present specification, a “logical operation” refers to a binary or multi-value logical operation.

An encryption processing apparatus of the present embodiment performs an operation by a full adder by using fully homomorphic encryption.

It is known that an AND circuit unit and an XOR circuit unit that configure the full adder included in the encryption processing apparatus respectively perform an operation for obtaining AND and an operation for obtaining XOR for encrypted data encrypted by Bit-wise type homomorphic encryption.

However, in order to achieve fully homomorphic encryption, it is necessary to perform a process of reducing an error, which is called Gate Bootstrapping to be described below, after the operation for obtaining AND or the operation for obtaining XOR.

This Gate Bootstrapping takes time. The encryption processing apparatus of the present embodiment reduces the range of error to be added to a plaintext to make a multiple binary input logical operation (a homomorphic operation) possible, thereby reducing the number of times of the homomorphic operation configuring the full adder.

Accordingly, the encryption processing apparatus of the present embodiment can reduce the number of times of Gate Bootstrapping performed in the subsequent stage of each homomorphic operation, thereby speeding up the operation by the full adder.

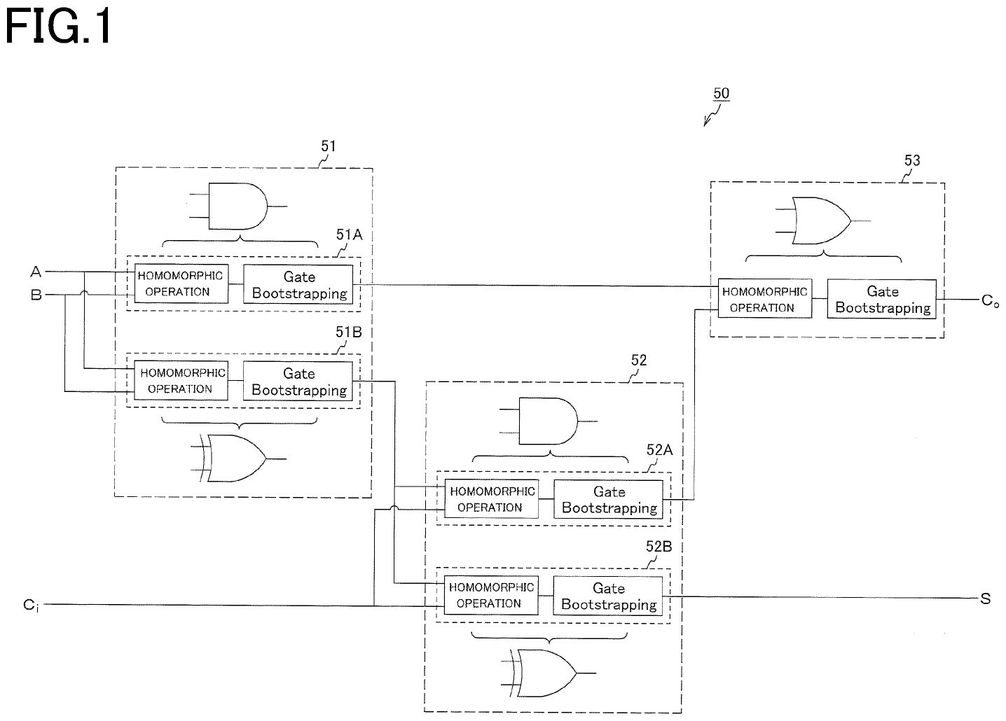

FIG. 1 is a diagram illustrating an example of a full adder circuit configured by a minimum number of logical operation elements.

Although FIG. 1 illustrates a full adder as a hardware circuit configured by logical operation elements, the full adder may be considered as a full adder program to be executed by a software implemented by a CPU.

When the processing for Bit-wise type homomorphic encryption is implemented by software, an operation is performed with a concept of designing a logic circuit (a logic gate) for a ciphertext.

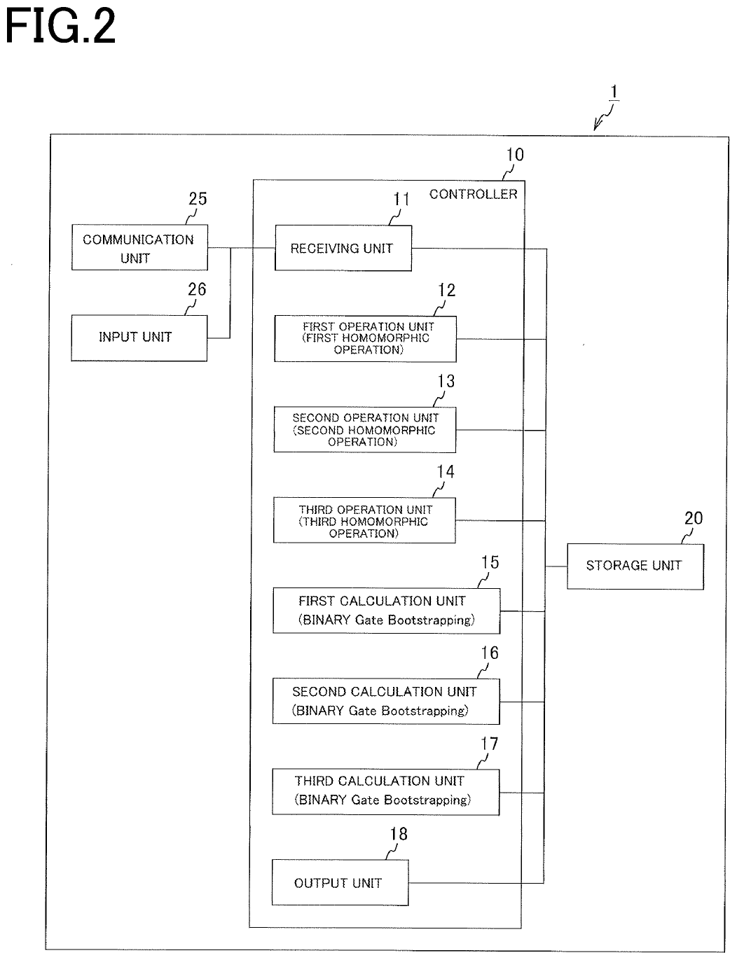

This description can also be applied to the encryption processing apparatus of the present embodiment described with reference to FIG. 2 and subsequent drawings.

A full adder circuit 50 is configured by two half adders 51 and 52 and an OR circuit unit (an arithmetic processing unit for obtaining OR) 53.

The first half adder 51 includes an AND circuit unit (an arithmetic processing unit for obtaining AND) 51A and an XOR circuit unit (an arithmetic processing unit for obtaining XOR) 51B.

The second half adder 52 includes an AND circuit unit (an arithmetic processing unit for obtaining AND) 52A and an XOR circuit unit (an arithmetic processing unit for obtaining XOR) 52B.

Inputs A and B to be added to each other are input to the AND circuit unit 51A and the XOR circuit unit 51B of the first half adder 51.

An output of the AND circuit unit 51A of the first half adder 51 and an output of the AND circuit unit 52A of the second half adder 52 are input to the OR circuit unit 53 in the latter stage, and a carry output Cₒ (Carry out) is output from the OR circuit unit 53.

An output from the XOR circuit unit 51B of the first half adder 51 and a carry input Cᵢ (Carry in) are input to the AND circuit unit 52A and the XOR circuit unit 52B of the second half adder 52.

An output S (Sum) of the full adder circuit 50 is output from the XOR circuit unit 52B of the second half adder 52.

As illustrated in FIG. 1, the full adder 50 includes two AND circuit units, two XOR circuit units, and an OR circuit unit and therefore includes five logical operation elements (processing units corresponding to the logical operation elements) in total.

Therefore, an operation by one full adder requires the operation time corresponding to the five logical operation elements. In TFHE described in the aforementioned paper, an operation by one logical operation element requires an operation time of about 16 ms, and the whole full adder 50 including five logical operation elements requires an operation time of about 80 ms.

When such a full adder is used for an operation of fully homomorphic encryption by TFHE, Gate Bootstrapping has to be performed in the latter stage of an operation (a homomorphic operation) performed in a first stage of each of the five logical operation elements. Gate Bootstrapping occupies almost all the processing time of a homomorphic logical operation.

Therefore, an operation of fully homomorphic encryption by the full adder circuit 50 in FIG. 1 can be considered as requiring the operation time corresponding to five times of Gate Bootstrapping.

An operation by each AND circuit unit and an operation by each XOR circuit unit in the half adder 51 and the half adder 52 have no dependence on each other. Therefore, in a case of configuring the full adder by software, operations can be performed in parallel in a multithreading manner, for example.

Performing operations in parallel enables an operation by a half adder to be performed in the operation time corresponding to one logical operation element.

Therefore, the operation by the one full adder illustrated in FIG. 1 can be performed in the operation time corresponding to three logical operation elements. However, the operation by one full adder requires an operation time of 48 ms even in this case. This time is substantially the same as the operation time required for performing Gate Bootstrapping three times.

TFHE is Bit-wise type encryption that is based on a logic gate such as an AND circuit unit or an XOR circuit unit.

By using a full adder, all of addition, subtraction, multiplication, and division (four arithmetic operations) of an integer and a comparison operation can be handled.

However, in Bit-wise type encryption, one ciphertext can only have 1 bit of information.

Addition, subtraction, multiplication, division, and comparison (comparison is equivalent to whether a result of subtraction is positive or negative) between integers are frequently used in various types of data processing, and handled data usually has a large bit length.

For example, it is necessary to process 32 ciphertexts in order to handle a 32-bit integer.

As for Bit-wise type fully homomorphic encryption, when addition or subtraction is performed for 32-bit integers, one half adder and 31 full adders are used. In multiplication, full adders the number of which is near 32 squared (1024) are used.

In order to make an operation (four arithmetic operations and comparison) of fully homomorphic encryption more practical, it is important to further enhance the speed of an operation by a full adder frequently used for the operation of fully homomorphic encryption.

As described below, the encryption processing apparatus of the present embodiment reduces the number of times of homomorphic operations reducing the range of error to be added to a plaintext to make a multiple binary input logical operation (a homomorphic operation) possible in the full adder used for fully homomorphic encryption in particular.

As a result, the encryption processing apparatus of the present embodiment can reduce the number of times of Gate Bootstrapping that requires a long operation time in the subsequent stage of a homomorphic operation and can largely reduce a processing time of fully homomorphic encryption.

FIG. 2 is an explanatory diagram of a functional configuration of the encryption processing apparatus of the present embodiment.

An encryption processing apparatus 1 includes a controller 10, a storage unit 20, a communication unit 25, and an input unit 26.

The controller 10 includes a receiving unit 11, a first operation unit 12, a second operation unit 13, a third operation unit 14, a first Bootstrapping unit (a first calculation unit) 15, a second Bootstrapping unit (a second calculation unit) 16, a third Bootstrapping unit (a third calculation unit) 17, and an output unit 18.

The first operation unit 12, the second operation unit 13, the first calculation unit 15, and the second calculation unit 16 are related to Examples 1 and 2 described later, and the third operation unit 14 and the third calculation unit 17 are related to Examples 3 and 4 described later.

The receiving unit 11 receives input of a ciphertext that is an object of an operation, via the communication unit 25 and the input unit 26.

In relation to Examples 1 and 2 described later, the first operation unit 12 performs a first homomorphic operation for three binary input ciphertexts received by the receiving unit 11.

The second operation unit 13 performs a second homomorphic operation between ciphertexts output from the first operation unit 12.

In relation to Example 3 described later, the third operation unit 14 performs a third homomorphic operation for the three binary input ciphertexts received by the receiving unit 11.

The first, second, and third operation units 12, 13, and 14 are arithmetic processing units each of which implements an operation (a homomorphic operation) of a full adder configured by the logic gates (the AND circuit unit and the XOR circuit unit) described in FIG. 1, by software, and at least one of the first, second, and third operation units 12, 13, and 14 may be implemented by hardware.

In relation to Examples 1 and 2, the first Bootstrapping unit 15 performs binary Gate Bootstrapping described below for the result of the operation by the first operation unit 12 to output a new ciphertext that can take two values as a carry out Cₒ.

The second Bootstrapping unit 16 performs binary Gate Bootstrapping described below for the result of the operation by the second operation unit 13 to output a new ciphertext that can take two values as an output S.

In relation to Example 3, the third Bootstrapping unit 17 performs binary Gate Bootstrapping described below for the result of the operation by the third operation unit 14 to output new ciphertexts that respectively indicate the output S and the carry out Cₒ.

The output unit 18 outputs a final operation result to outside of the encryption processing apparatus 1 or to another processing process performed in the encryption processing apparatus 1.

The storage unit 20 can store therein an input ciphertext, a temporary file and temporary data used in an operation by a full adder, and an output ciphertext.

An encrypted encryption database 60 can also be stored in the storage unit 20.

The communication unit 25 connects the encryption processing apparatus 1 to a network, thereby enabling communication between the encryption processing apparatus 1 and an external device.

The encryption processing apparatus 1 can serve as a database server by storing the encrypted encryption database 60 in the storage unit 20 and including the communication unit 25. In this case, the encryption processing apparatus 1 can receive an encrypted query from a terminal device as the external device, search the encrypted encryption database 60, and send an encrypted search result to the terminal device.

The input unit 26 inputs a ciphertext that is an object of arithmetic processing to the encryption processing apparatus 1.

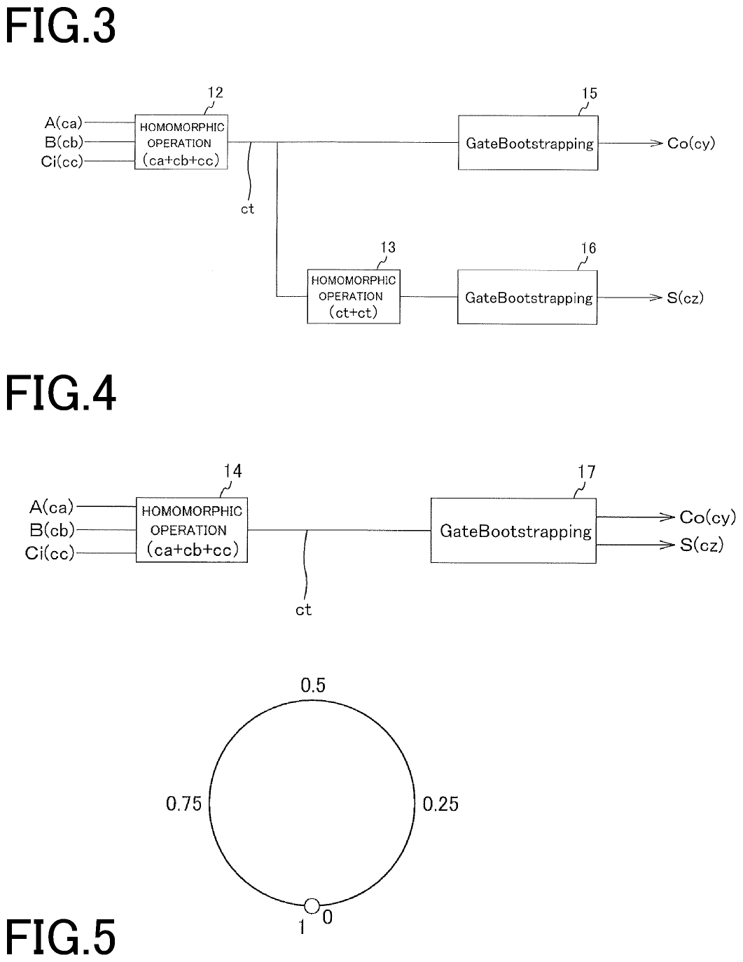

FIG. 3 is a detailed explanatory diagram of an operation process of a full adder based on the functional configuration in FIG. 2 in relation to Examples 1 and 2.

In the descriptions of FIG. 3, ciphertexts ca, cb, and cc input to the encryption processing apparatus 1 are all TLWE ciphertexts described in the aforementioned paper.

TLWE encryption is Bit-wise type fully homomorphic encryption that has 0 or a value μ (non-0) as a plaintext, which will be descried in detail below.

Various operations can be performed by logical operations using logic gates.

Further, as described later, a TLWE ciphertext has either of two values as a plaintext, each value being obtained by adding an error with a predetermined variance to a predetermined value corresponding to a binary symbol 0 or 1. The TLWE ciphertext can be subjected to a logical operation without being decrypted.

The configuration illustrated in FIG. 3 uses (binary) Gate Bootstrapping presented in Chillotti et al., 2020.

Gate Bootstrapping in TFHE presented in the aforementioned paper will be described in detail below.

In Examples 1 and 2, the input ciphertexts ca, cb, and cc are input to the first operation unit 12 and are subjected to a homomorphic operation, and the operation result (a ciphertext ct=ca+cb+cc) is input to the first Bootstrapping unit 15 that performs binary Gate Bootstrapping.

The output of the first Bootstrapping unit 15 is a ciphertext cy as the carry out Cₒ which can take either one of two values 0 and μ as the plaintext.

The ciphertext ct=ca+cb+cc is input to the second operation unit 13. A homomorphic operation between the ciphertexts ct is then performed, and its output is input to the second calculation unit 16 and subjected to binary Gate Bootstrapping, so that a ciphertext cz as the output S is output.

A time required for the homomorphic operation by the first operation unit 12 and a time required for the homomorphic operation by the second operation unit 13 are very short.

Gate Bootstrapping consumes almost all processing time when processing is performed by a full adder by using a homomorphic operation.

In a case of performing an operation of a full adder using binary Gate Bootstrapping as in the full adder circuit 50 illustrated in FIG. 1, it is necessary to perform Gate Bootstrapping once in the subsequent stage in each of the AND circuit units 51A and 52A, the XOR circuit units 51B and 52B, and the OR circuit unit 53, i.e., five times in total.

Meanwhile, the encryption processing apparatus 1 of Examples 1 and 2 reduces the number of times of the homomorphic operation processing to two in total by inputting three binary ciphertexts to the first operation unit 12 and improving Gate Bootstrapping.

Consequently, the encryption processing apparatus 1 can reduce the number of times of Gate Bootstrapping that occupies almost all the homomorphic operation processing to two in total. Therefore, the encryption processing apparatus 1 can reduce a computation processing time by about 60%, as compared with the full adder circuit 50 illustrated in FIG. 1.

Further, the encryption processing apparatus 1 may perform the processing by the first Bootstrapping unit 15 and the processing by the second Bootstrapping unit 16 in parallel by multithreading. In this case, the encryption processing apparatus 1 can reduce the number of stages of Bootstrapping that occupies a large part of the processing time in an operation of a full adder to one. Meanwhile, although the full adder circuit 50 illustrated in FIG. 1 can cause the AND circuit unit 51A and the XOR circuit unit 51B to perform operations in parallel and cause the AND circuit unit 52A and the XOR circuit unit 52B to perform operations in parallel, the number of stages of Bootstrapping in total is three. Therefore, also in a case of using parallel processing, the encryption processing apparatus 1 can reduce the computation processing time by about 66%, as compared with the full adder circuit 50 illustrated in FIG. 1.

As described above, since Gate Bootstrapping occupies almost all the operation time of a full adder related to fully homomorphic encryption, the encryption processing apparatus 1 can remarkably speed up an operation of the full adder by reducing the number of times of Gate Bootstrapping.

Gate Bootstrapping explained in TFHE is described in detail.

Gate Bootstrapping is a method for making fully homomorphic encryption, which has not been practical because of a huge amount of data and its operation time, practical.

TFHE in the aforementioned paper uses encryption in which LWE (Learning with Errors) encryption is configured over a circle group, so called “TLWE encryption”, and achieves various types of homomorphic logical operations (and furthermore any operation such as addition or multiplication) between TLWE ciphertexts at high speed with small data size while making an error in an operation small.

An input of Gate Bootstrapping in TFHE is a TLWE ciphertext encrypted with a private key.

TFHE achieves fully homomorphic encryption (FHE) based on TLWE ciphertexts.

TLWE encryption is a unique case of LWE encryption (obtained by defining LWE encryption over a circle group) that is one type of lattice-based cryptography.

TLWE encryption is additively homomorphic and is known as being able to perform an additive operation between plaintexts encrypted by TLWE encryption without decrypting ciphertexts.

FIG. 5 is an image diagram for explaining a circle group that TLWE encryption has as a plaintext.

TLWE encryption has a real number μ, as a plaintext, that moves forward from 0 with a real number precision and, when reaching 1, returns to 0 and that corresponds to a point 0 on a circle group {T} illustrated in FIG. 5 or any point (non-0) other than 0 on the circle group {T}. TLWE encryption itself regards any point on a circle group as a plaintext, and uses a range near 0 (including an error) and a range near μ (including an error) as a plaintext.

The point on the circle group {T} is also described as an “element” in the present specification.

An encryption processing apparatus handling TFHE performs a generic homomorphic operation, for example, an additive operation as an operation between such TLWE ciphertexts, and makes an error of the operation result fall within an appropriate range by Gate Bootstrapping, thereby achieving fully homomorphic encryption (FHE) that allows a logical operation to be performed again (in the latter stage).

### TLWE Encryption

TLWE encryption is described.

A vector [a] obtained by collecting N random numbers uniformly distributed is prepared as an element on the circle group {T}. In addition, a private key [s] obtained by collecting N values that can be 0 or 1 is prepared.

Assuming that a random number in the Gaussian distribution (the normal distribution) in which an average value is a plaintext μ and a variance is preset to α is e, an example of a TLWE ciphertext is a pair ([a], [s]·[a]+e).

An average value of e when an infinite number of TLWE ciphertexts are created for the same plaintext μ is a plaintext μ, where μ is a plaintext without an error and e is a plaintext with an error.

Symbol “·” represents a dot product of vectors. This description is also applied to the following descriptions.

When [s]·[a]+e described above is written as b, the TLWE ciphertext can be represented as ([a], b).

A function φₛ(([a], b)=b−[s]·[a]=e is a function of decrypting the TLWE ciphertext. Since TLWE encryption adds a dot product of a private key vector and a random number vector and an error to a plaintext to encrypt the plaintext, TLWE encryption can be decrypted with the error by calculating the dot product of the private key vector and the random number vector. At this time, if the private key vector is unknown, a component serving as the dot product cannot be calculated, and therefore decryption cannot be performed.

This TLWE encryption is additively homomorphic and allows an additive operation between plaintexts of TLWE ciphertexts to be performed without decrypting the ciphertexts.

When ([a]+[a′], b+b′) obtained by adding two TLWE ciphertexts ([a], b) and ([a′], b′) together as they are is input to the aforementioned decryption function φₛ, a sum of the two plaintexts is obtained as represented by

φₛ(([a]+[a′], b+b′))=(b+b′)−[s]·([a]+[a′])=(b−[s]·[a])+(b′−[s]·[a′])=φₛ([a], b)+φₛ([a′], b′).

It is thus found that a TLWE ciphertext is a ciphertext obtained by “additive homomorphic encryption”.

In TFHE in the aforementioned paper, various operations are achieved by repeating “performing an additive operation for TLWE ciphertexts each obtained by adding an error to a plaintext and reducing an error by Gate Bootstrapping”.

In the following descriptions, a trivial ciphertext such as ([0], μ) is a TLWE ciphertext that can be decrypted with any private key, that is, a ciphertext that can be decrypted with any private key to provide the same plaintext.

In ([0], μ), [0] represents a zero vector.

Although the “trivial ciphertext” can be handled as a TLWE ciphertext, it can be considered as a state where a plaintext is placed in the ciphertext substantially as it is.

When the decryption function φₛ is applied to the TLWE ciphertext ([0], μ), the private key [s] is multiplied by the zero vector [0] to disappear as represented by φₛ(([0], μ))=μ−[s]·0=μ. The plaintext μ is thus obtained easily. Such a ciphertext is a trivial ciphertext with regard to the plaintext μ.

A finite cyclic group used in Gate Bootstrapping in TFHE is described.

Gate Bootstrapping uses a factor ring of a polynomial ring as a finite cyclic group.

The following description explains that a factor ring of a polynomial ring is a finite cyclic group.

An n-th degree polynomial is generally represented by aₙxⁿ+aₙ₋₁xⁿ⁻¹+ . . . +a₀.

These all sets form a commutative group for a sum of polynomials f(x)+g(x).

Further, a product of polynomials f(x)g(x) has properties identical to those of the commutative group except that an inverse element is not necessarily present. Such a structure is called “monoid”.

Regarding the sum and the product of polynomials, the distributive property is established as follows.

f(x){g(x)+g′(x)}=f(x)g(x)+f(x)g′(x)

Therefore, when the sum and the product of polynomials are defined using polynomials as elements, a “ring” is formed, which is called “polynomial ring”.

TFHE uses a polynomial ring including the circle group {T} as coefficients, and such a polynomial ring is represented as T[X].

When a polynomial T(X), which is a polynomial ring, is decomposed into T[X](Xⁿ+1)+T[X], and only remainders are extracted and collected, a factor ring of a polynomial ring is obtained because the remainders also form a “ring”.

In TFHE, a factor ring of a polynomial ring is represented as T[X]/(Xⁿ+1).

A polynomial F(X)=μXⁿ⁻¹+μXⁿ⁻²+ . . . +μX+μ is extracted by using a desired coefficient μ (μ belongs to T) as an element of the factor ring of the polynomial ring T[X]/(Xⁿ+1).

When the element F(X) of the factor ring of the polynomial ring is multiplied by X, μXⁿ⁻¹+μXⁿ⁻²+ . . . +μX−μ is obtained, the coefficient of the top term appears as a constant term with a sign reversed from positive to negative.

When multiplication by X is further performed, the same phenomenon happens again as represented by μXⁿ⁻¹+μXⁿ⁻²+ . . . +μX²−μX−μ (the coefficient of the top term appears as a constant term with a sign reversed from positive to negative).

When this multiplication is repeated n times, −μXⁿ⁻¹−μXⁿ⁻² . . . −μX−μ is obtained, so that the coefficients of all terms become negative.

When multiplication by X is further continued, the coefficient of the top term becomes positive from negative and appears as a constant term as represented by

−μXⁿ⁻¹−μXⁿ⁻² . . . −μX+μ,

−μXⁿ⁻¹−μXⁿ⁻² . . . +μX+μ.

When multiplication by X is repeated 2n times in total, the multiplication result returns to the original element of the factor ring of the polynomial ring F(X)=μXⁿ⁻¹+μXⁿ⁻²+ . . . +μX+μ. As described above, the highest-order coefficient (μ) appears as the lowest-order constant term with a reversed sign (−μ), and terms are shifted by one in whole.

That is, the polynomial F(X)=μXⁿ⁻¹+μXⁿ⁻²+ . . . +μX+μ is a finite cyclic group of order 2n in a ring that is the factor ring of the polynomial ring T[X]/(Xⁿ+1).

In TFHE, an encryption processing apparatus achieves fully homomorphic encryption by using such properties of the polynomial F(X) based on a factor ring of a polynomial ring.

### TRLWE Encryption

Gate Bootstrapping uses encryption called TRLWE encryption in addition to TLWE encryption.

TRLWE encryption is described.

The character R in TRLWE encryption means a ring, and TRLWE encryption is LWE encryption configured by a ring. TRLWE is also additive homomorphic encryption, as TLWE encryption is.

A ring in TRLWE encryption is the factor ring of a polynomial ring T[X]/(Xⁿ+1) described above.

In order to obtain TRLWE encryption, elements of the factor ring of a polynomial ring T[X]/(Xⁿ+1) are selected at random.

In fact, n coefficients in an (n−1)th degree polynomial are selected as uniformly distributed random numbers from the circle group {T}.

When the degree of the polynomial is n−1, the polynomial is not divided by Xⁿ+1, and it is not necessary to consider a remainder. Therefore, it is assumed that the (n−1)th degree polynomial is a polynomial a(X).

A polynomial s(X) used as a private key is structured as follows, by collecting n values each of which can be 0 or 1 at random.

s(X)=sₙ₋₁Xⁿ⁻¹+sₙ₋₂Xⁿ⁻²+ . . . s₁X+s₀

Assuming that n random numbers eᵢ are random numbers in the Gaussian distribution (the normal distribution) in which an average value is a plaintext μᵢ and a variance is α, the following polynomial e(X) is structured from these random numbers.

e(X)=eₙ₋₁Xⁿ⁻¹+eₙ₋₂Xⁿ⁻²+ . . . e₁X+e₀

Decomposition of s(X)·a(X)+e(X) is performed into f(X)(Xⁿ+1)+b(X), and b(X) is obtained.

Consequently, (a(X), b(X)) is obtained as a TRLWE ciphertext.

In TRLWE encryption, encryption is performed using random numbers similarly to TLWE encryption, and therefore innumerable ciphertexts can correspond to the same private key and the same plaintext.

In addition, in TRLWE encryption, g(X) is determined in such a manner that φₛ becomes an element of T[X]/(Xⁿ+1) serves as a decryption function, where φₛ((a(X), b(X))=b(X)−s(X)·a(X)+g(X)(Xⁿ+1), as in TLWE encryption.

### Gadget Decomposition

Gadget Decomposition is described.

A coefficient in a polynomial used in a TRLWE ciphertext is a real number that is an element of the circle group {T} in FIG. 5 and is equal to or larger than 0 and less than 1, and only has a fractional part.

An operation of decomposing this coefficient into several bits in binary notation is defined as Gadget Decomposition (Dec) in TFHE in the aforementioned paper.

For example, assuming that the degree n of the polynomial F(X) of a TRLWE ciphertext is 2, one unit of decomposition is Bg=2², and decomposition into l=3 elements is performed. At this time, each element is arranged to enter between −Bg/2 and Bg/2.

A TRLWE ciphertext is a combination of two polynomials like (a(X), b(X)) as described above. Therefore, a TRLWE ciphertext d can be written as

d=[0.75X²+0.125X+0.5, 0.25X²+0.5X+0.375]

by being regarded as a two-dimensional vector having polynomials that serve as elements of a factor ring of a polynomial ring, as elements. Accordingly, in the following descriptions, each element is decomposed into the form of a sum of powers of Bg⁻¹=0.25.

Since 0.75=−0.25 is established on the circle group {T}, decomposition can be performed as follows.

$$d = [ 0.75 {X}^{2} + 0.125 X + 0.5 , 0.25 {X}^{2} + 0.5 X + 0.3 \; 75 ] = [ - 0.25 {X}^{2} + 0.125 X + 0.5 , 0.25 {X}^{2} + 0.5 X + 0.25 + 0.1 \; 25 ] = [ 0.25 \times ( - {X}^{2} + 2 ) + {0.25}^{2} \times 2 X + 0.2 {5}^{3} \times 0 , 0.25 \times ( {X}^{2} + 2 X + 1 ) 9 + 0.25 {X}^{2} \times 2 + 0.2 {5}^{3} \times 0 ]$$

Therefore, when Gadget Decomposition is performed, a vector

Dec(d)=[−X²+2, 2X, 0, X²+2X+1, 2, 0]

is obtained.

An operator H of inverse transform from a vector to a ciphertext is also defined.

When the description is provided based on the example described above, a matrix

$$H = ( \begin{matrix}0.25 & 0 \\ {0.25}^{2} & 0 \\ {0.25}^{3} & 0 \\ 0 & 0.25 \\ 0 & {0.25}^{2} \\ 0 & {0.25}^{3}\end{matrix} )$$

becomes the operator H of inverse transform. A TRLWE ciphertext d′ is obtained by performing an operation Dec(d)·H. The lower bits are rounded off.

It can also be said that an operation of obtaining [v] that makes ∥d−[v]·H∥ minimum with respect to the TRLWE ciphertext d is Gadget Decomposition. Here, ∥ is a vector norm (length).

Ciphertexts Zi=(a(X), b(X)) formed by polynomials in which all coefficients of e(X) have an average value of 0 and a variance is α are created. The number of the created ciphertexts is 2l.

The plaintext μ is encrypted in the following manner, whereby the following ciphertext k is obtained.

$$k = ( \begin{matrix}{Z}_{1} \\ {Z}_{2} \\ ⋮ \\ \end{matrix} ) + μ \times H$$

This ciphertext k is defined as a TRGSW ciphertext BK.

The TRGSW ciphertext BK configures a Bootstrapping Key used below.

The Bootstrapping Key is described.

The Bootstrapping Key is used for encrypting a private key in order to use the private key in Gate Bootstrapping.

Separately from the private key [s] (Nth degree) used for TLWE ciphertexts, each element of a private key [s′] for encrypting the private key [s] is selected to be either of two values, i.e., 0 or 1 for use in Gate Bootstrapping.

It is necessary to make the degree of the private key [s′] the same as the degree n of polynomials used in TRLWE encryption.

The TRGSW ciphertext BK is created for each element of the private key [s].

When decryption with the private key [s′] is performed, 2l TRLWE ciphertexts Zj are created where φ_{s′}(Zj)=0 is satisfied.

BKᵢ is then represented by

$${BK}_{i} = ( \begin{matrix}{Z}_{1} \\ {Z}_{2} \\ ⋮ \\ \end{matrix} ) + {s}_{i} \cdot H$$

as in the above-described configuration of the TRGSW ciphertext.

N TRGSW ciphertexts having this configuration are prepared, where N is the same as the degree of the private key [s]. A set of the thus prepared TRGSW ciphertexts is referred to as “Bootstrapping Key”.

A cross product of the TRGSW ciphertext BKi and the TRLWE ciphertext d is defined as follows.

BKi×d=Dec(d)·BKi

Gadget Decomposition is an operation of obtaining [v] that makes ∥d−[v]·H∥ minimum with respect to the TRLWE ciphertext d.

Therefore, by using [v]=Dec(d) and an error (εₐ(X), ε_{b}(X)), [v]·H=d+(εₐ(X), ε_{b}(X)) can be written.

As a result,

$$BKi \times d = Dec ( d ) \cdot BKi = \vec{v} \cdot ( \begin{matrix}{Z}_{1} \\ {Z}_{2} \\ ⋮ \\ \end{matrix} ) + {s}_{i} \times \vec{v} \cdot H$$

is obtained.

When the left side calculates a dot product, and [v]·H=d+(εₐ(X), ε_{b}(X)) is substituted into the right side,

= [symbol] vⱼ×Zⱼ+sᵢ×(d+(ϵₐ(X), ϵ_{b}(X)))

= [symbol] vⱼ×Zⱼ+sᵢ×d+sᵢ×(ϵₐ(X), ϵ_{b}(X))

is obtained, and becomes the same as calculation of a sum of the following three ciphertexts c1, c2, and c3.

c₁= [symbol] vⱼ×Zⱼ

c₂=sᵢ×d

c₃=sᵢ×(ϵₐ(X), ϵ_{b}(X))

Since TRLWE encryption is additive homomorphic encryption, calculating a sum of ciphertexts is the same as calculating a sum of plaintexts.

Since c₁ is obtained by adding several times of Zⱼ, an expected value of the plaintext φ_{s′}(c₁) is 0.

In addition, φ_{s′}(c₃) obtained by decryption is set to be sufficiently small also in the subsequent operations, because the magnitude of the absolute value of a plaintext can be limited by a system parameter.

In this case, φ_{s′}(BKi×d)=φ_{s′}(sᵢ×d) is obtained, but the calculation result is the sum of the above three ciphertexts c1, c2, and c3 regardless of whether sᵢ is 0 or 1. Whether sᵢ is 0 or 1 cannot be determined by a simple comparison.

Assuming that there are TRLWE ciphertexts d₀ and d₁ respectively corresponding to two plaintexts μ₀ and μ₁, when d₁-d₀ is substituted for d, and d₀ is finally added, the following CMux function is completed.

CMux(BKᵢ, d₀, d₁)=BKi×(d₁−d₀)+d₀=Dec(d₁−d₀)·BKᵢ+d₀

The CMux function outputs a ciphertext of the plaintext to without decrypting the ciphertext when sᵢ is 0, and outputs a ciphertext of the plaintext μ₁ without decrypting the ciphertext when sᵢ is 1.

Although the CMux function can calculate the ciphertext of the plaintext μ₀ or the plaintext μ₁, it is not possible to know which one is selected.

Binary Gate Bootstrapping in TFHE is performed using the various information described above.

Binary Gate Bootstrapping is configured by three steps described below, i.e., (1) BlindRotate, (2) SampleExtract, and (3) KeySwitching.

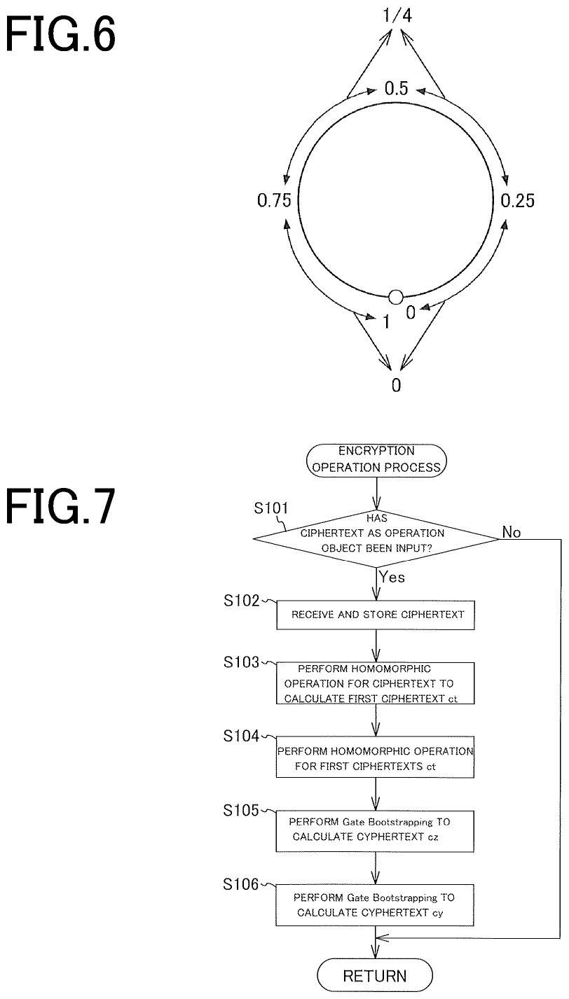

FIG. 6 is an operation image diagram of binary Gate Bootstrapping.

Binary Gate Bootstrapping reduces an error for a plaintext included in a result of a homomorphic operation between TLWE ciphertexts by three steps descried below.

In the following descriptions, unless otherwise specified, a plaintext means a result of an operation between plaintexts obtained as a result of an operation between TLWE ciphertexts.

A plaintext in a section from 0 to 0.25 (¼) or 0.75 (¾) to 1 on the circle group {T} in FIG. 5 is converted to a TLWE ciphertext 0, and a plaintext in a section from 0.25 (¼) to 0.75 (¾) is converted to a ciphertext 0.25 (¼).

An error added to the plaintext in this conversion is any error in a range of ± 1/16.

### (1) BlindRotate

BlindRotate is performed as the first step of Gate Bootstrapping.

BlindRotate is a process of creating a TRLWE ciphertext.

In BlindRotate, from a trivial TRLWE ciphertext (0, T(X)) whose plaintext is a polynomial T(X), a TRLWE ciphertext multiplied by X^{-φs(c′)} is obtained without decryption. “0” indicates a 0th degree polynomial 0.

Here, φs(c′) is a plaintext obtained by applying a decryption function to the following LWE ciphertext c′.

In BlindRotate, the following polynomial T(X)

T(X)=F(X)·X^{n/2}

is prepared, which is obtained by multiplying the following polynomial F(X)

F(X)=μXⁿ⁻¹+μXⁿ⁻²+ . . . μX+μ

where μ=⅛,
that forms the above-described finite cyclic group and serves as a test vector, by X^{n/2}.

It is assumed that there is a TLWE ciphertext c obtained by encrypting the plaintext μ1 with the private key [s].

Each element of this TLWE ciphertext c=([a], b) is multiplied by 2n and is then rounded off, whereby a LWE ciphertext c′=([a′], b′) is obtained.

When the LWE ciphertext c′=([a′], b′) is decrypted, μ1′=φₛ(c′)≈2n×φₛ(c)=2nμ1 is obtained. As n becomes larger, an error becomes smaller relatively.

A trivial TRLWE ciphertext (0, T(X)) whose plaintext is the polynomial T(X) is prepared, and it is assumed that A₀=X^{-b′}×(0, T(X))=(0, X^{-b′}×T(X)), where 0 indicates a 0th degree polynomial 0. Since b′ is an integer, a power of X can be defined naturally.

Subsequently, Aᵢ=CMux(BKᵢ, Aᵢ₋₁, X^{a′i}Aᵢ₋₁) is calculated in turn by using BKᵢ that is the above-described Bootstrapping Key. Since a′i is an integer also in this expression, a power of X can be defined naturally.

Accordingly, the plaintext is not changed as it is when sᵢ is 0, and multiplication by X^{a′i} is performed in turn when sᵢ is 1.

Therefore, when calculation is repeated as represented by

ϕ_{s′}(A₀)=X^{-b′}T(X)

ϕ_{s′}(A₁)=X^{s}^{₁}^{a′}^{₁}^{-b′}T(X)

ϕ_{s′}(A₂)=X^{s}^{₂}^{a′}^{₂}^{+s}^{₁}^{a′}^{₁}^{-b′}T(X),

then

ϕ_{s′}(Aₙ)=X^{Σ}^{ᵢ₌₁}^{^{N}}^{s}^{ᵢ}^{×a′}^{ᵢ}^{-b′}T(X)

is obtained.

Here,

Σᵢ₌₁^{N}sᵢ×a′ᵢ−b′

is equal to the decryption function φs(c′) with a sign reversed. Therefore,

ϕ_{s′}(Aₙ)=X^{-ϕ}^{ₛ}^{(c′)}T(X)

is obtained. Here, φx′(Aₙ) is a ciphertext of a polynomial obtained by multiplying μ1′ times the polynomial T(X) by X⁻¹.

In association with the plaintext μ1 of the TLWE ciphertext c related to BlindRotate, unique values (up to 2n values including n coefficients and n values obtained by reversing the signs of the coefficients) in accordance with the number of times μ1′ (=2nμ1) of multiplying the polynomial T(X) by X is obtained, and therefore this can be regarded as a kind of Look Up Table.

In association with the plaintext μ1 of the TLWE ciphertext c related to BlindRotate, unique values (up to 2n values including n coefficients and n values obtained by reversing the signs of the coefficients) in accordance with the number of times μ1′ (=2nμ1) of multiplying the polynomial T(X) by X is obtained, and therefore this can be regarded as a kind of Look Up Table.

### (2) SampleExtract

In the plaintext polynomial φ_{s′}(Aₙ) obtained by decrypting the TRLWE ciphertext Aₙ obtained by BlindRotate in (1), n/2−φₛ(c′) terms from the lowest term have a coefficient of −μ. When φ_{s′}(Aₙ) is negative, coefficients are −μ from the highest term in turn conversely.

When attention is paid only to a constant term of the plaintext polynomial φ_{s′}(Aₙ) obtained by decrypting the TRLWE ciphertext Aₙ, the constant term is μ if φₛ(c′) is equal to or greater than n/2 and less than 3n/2, that is, φₛ(c) is ½±¼. Otherwise, i.e., if φₛ(c) is ±¼, the constant term is −μ.

SampleExtract is a process for extracting only the coefficient of the constant term of the plaintext polynomial φ_{s′}(Aₙ) from the TRLWE ciphertext Aₙ obtained by BlindRotate in (1) without decrypting the TRLWE ciphertext Aₙ, thereby obtaining a TLWE ciphertext cs.

The process for obtaining the TLWE ciphertext cs is described.

All TRLWE ciphertexts can be expressed as (A(X), B(X)) by putting polynomials

A(X)=Σᵢ₌₁ⁿaᵢXⁱ⁻¹

B(X)=Σᵢ₌₁ⁿbᵢXⁱ⁻¹,

where n is the degree.

When decryption with the private key [s′] is performed, the expression can be expanded by putting a polynomial of the private key as

S′(X)=Σⱼ₌₁ⁿs′ⱼX^{j-1}.

### Then,

ϕ_{s′}(c)=B(X)−S′(X)·A(X)=Σᵢ₌₁ⁿbᵢXⁱ⁻¹−Σᵢ₌₁ⁿΣⱼ₌₁ⁿaᵢs′ⱼX^{(i+j-2)}

is obtained.

The following operation is then performed with regard to this expression.

$${\sum }_{i = 1}^{n} {b}_{i} {X}^{i - 1} - {\sum }_{i = 1}^{n} {\sum }_{j = 1}^{n} {a}_{i} {s}_{j}^{′} {X}^{( i + j - 2 )} = {\sum }_{i = 1}^{n} {b}_{i} {X}^{i - 1} - {\sum }_{i = 1}^{n} {\sum }_{j = i - 1}^{n + i - 2} {a}_{i} {s}_{j - i + 2}^{′} {X}^{j} = {\sum }_{i = 1}^{n} {b}_{i} {X}^{i - 1} - {\sum }_{i = 1}^{n} {\sum }_{j = i - 1}^{n - 1} {a}_{i} {s}_{j - i + 2}^{′} {X}^{j} - {\sum }_{i = 1}^{n} {\sum }_{j = n}^{n + i - 2} {a}_{i} {s}_{j - i + 2}^{′} {X}^{j} = {\sum }_{j = 1}^{n} {b}_{j} {X}^{j - 1} - {\sum }_{j = 0}^{n - 1} {\sum }_{i = 1}^{j + 1} {a}_{i} {s}_{j - i + 2}^{′} {X}^{j} - {\sum }_{j = n}^{2 n - 2} {\sum }_{i = j - n + 2}^{n} {a}_{i} {s}_{i = j - n + 2}^{′} {X}^{j} = {\sum }_{j = 0}^{n = 1} {b}_{j + 1} {X}^{j} - {\sum }_{j = 0}^{n - 1} {\sum }_{i = 0}^{j} {a}_{i + 1} {s}_{j - i + 1}^{′} {X}^{j} - {\sum }_{j = 0}^{n - 2} {\sum }_{i = j - n + 1}^{- 1} {a}_{i + n + 1} {s}_{j - i + 1}^{′} {X}^{j + n} = {\sum }_{j = 0}^{n - 2} {b}_{j + 1} {X}^{j} + {b}_{n} {X}^{n - 1} - {\sum }_{j = 0}^{n - 2} {\sum }_{i = 0}^{j} {a}_{i + 1} {s}_{j - i + 1}^{′} {X}^{j} - {\sum }_{i = 0}^{n - 1} {a}_{i + 1} {s}_{n - i}^{′} {X}^{n - 1} - {\sum }_{j = 0}^{n - 2} {\sum }_{i = j - n + 1}^{- 1} {a}_{i + n + 1} {s}_{j - i + 1}^{′} {X}^{j + n} = {\sum }_{j = 0}^{n - 2} ( {b}_{j + 1} {X}^{j} - {\sum }_{i = 0}^{j} {a}_{i + 1} {s}_{j - i + 1}^{′} {X}^{j} - {\sum }_{i = j - n + 1}^{- 1} {a}_{i + n + 1} {s}_{j - i + 1}^{′} {X}^{j + n} ) + {b}_{N} {X}^{n - 1} - {\sum }_{i = 0}^{n - 1} {a}_{i + 1} {s}_{n - i}^{′} {X}^{- 1}$$

Since this is “factor ring of polynomial ring”, a remainder when this is divided by (Xⁿ+1) is calculated. Then,

$${\sum }_{j = 0}^{n - 2} ( {b}_{j + 1} {X}^{j} - {\sum }_{i = 0}^{j} {a}_{i + 1} {s}_{j - i + 1}^{′} {X}^{j} + {\sum }_{i = j - n + 1}^{- 1} {a}_{i + n + 1} {s}_{j - i + 1}^{′} {X}^{j} ) + {b}_{N} {X}^{n - 1} - {\sum }_{i = 0}^{n - 1} {a}_{i + 1} {s}_{n - i}^{′} {X}^{n - 1} = {\sum }_{j = 0}^{n - 2} ( {b}_{j + 1} - {\sum }_{i = 0}^{j} {a}_{i + 1} {s}_{j - i + 1}^{′} + {\sum }_{i = j - n + 1}^{- 1} {a}_{i + n + 1} {s}_{j - i + 1}^{′} ) {X}^{j} + ( {b}_{n} - {\sum }_{i = 0}^{- 1} {a}_{i + 1} {s}_{n - i}^{′} ) {X}^{n - 1}$$

is obtained.

Further, when

$${a}_{i}^{′} = \{ \begin{matrix}{a}_{i} & ( i \geq 1 ) \\ - {a}_{i + n} & ( otherwise )\end{matrix}$$

$$is put , then$$

$$= {\sum }_{j = 0}^{n - 2} ( {b}_{j + 1} - {\sum }_{i = 0}^{j} {a}_{i + 1}^{′} {s}_{j - i + 1}^{′} - {\sum }_{i = j - n + 1}^{- 1} {a}_{i + 1}^{′} {s}_{j - i + 1}^{′} ) {X}^{j} + ( {b}_{N} - {\sum }_{i = 0}^{n - 1} {a}_{i + 1}^{′} {s}_{n - i}^{′} ) {X}^{n - 1}$$

$$= {\sum }_{j = 0}^{n - 2} ( {b}_{j + 1} - {\sum }_{i = j - n + 1}^{j} {a}_{i + 1}^{′} {s}_{j - i + 1}^{′} ) {X}^{j} - ( {b}_{N} - {\sum }_{i = 0}^{n - 1} {a}_{i + 1} {s}_{n - i}^{′} ) {X}^{n - 1}$$

$$= {\sum }_{j = 0}^{n - 2} ( {b}_{j + 1} - {\sum }_{i = 0}^{n - 1} {a}_{i + j - n + 2}^{′} {s}_{n - i}^{′} ) {X}^{j} + ( {b}_{n} - {\sum }_{i = 0}^{n - 1} {a}_{i + 1} {s}_{n - i}^{′} ) {X}^{n - 1}$$

$$= {\sum }_{j = 0}^{n - 1} ( {b}_{j + 1} - {\sum }_{i = 0}^{n - 1} {a}_{i + j - n + 2}^{′} {s}_{n - i}^{′} ) {X}^{j}$$

is obtained, and coefficients of respective terms in a plaintext polynomial are obtained from

ϕ_{s′}(c)=Σⱼ₌₀ⁿ⁻¹(bⱼ₊₁−Σᵢ₌₀ⁿ⁻¹a′ᵢ₊ⱼ₋ₙ₊₂s′ₙ₋ᵢ)X^{j}.

Among the obtained coefficients, a coefficient of a constant term is necessary. Therefore, when a coefficient for j=0 is extracted,

b₁−Σᵢ₌₀ⁿ⁻¹a′ᵢ₋ₙ₊₂s′ₙ₋ᵢ

is obtained. When

a″ᵢ=a′₋ᵢ₊₂

is put, the extracted coefficient can be transformed to a decryption function of TLWE encryption as represented by

b₁−Σᵢ₌₀ⁿ⁻¹a″ₙ₋ᵢs′ₙ₋ᵢ=b₁−Σᵢ₌₀ⁿ⁻¹a″ᵢs′ᵢ=b₁−\vec{s′}·\vec{a″}=ϕ_{s′}(\vec{a″}, b₁)

That is, when coefficients are extracted from the TRLWE ciphertext Aₙ=(A(X), B(X)) obtained by BlindRotate in (1) while the coefficients are set as

$${a}_{i}^{″} = \{ \begin{matrix}{a}_{1} & ( i = 1 ) \\ - {a}_{- i + n + 2} & ( otherwise )\end{matrix} ,$$

a new TLWE ciphertext ([a″], b₁) is obtained which has, as a plaintext, the same value as a constant term of a plaintext polynomial corresponding to the original TRLWE ciphertext Aₙ. This new TLWE ciphertext is the output of SampleExtract has either of two types, i.e., −μ or μ as a plaintext.

A TLWE ciphertext cs=([a″], b₁)+([0], μ) obtained by adding a trivial ciphertext ([0], μ) of which plaintext is μ to the thus obtained TLWE ciphertext is obtained.

Specifically, since μ is ⅛ in the polynomial F(X) as a test vector, a ciphertext of −⅛ or ⅛ is obtained in this stage.

When a trivial TLWE ciphertext ([0], ⅛) of which a plaintext is μ=⅛ is added to the output result of SampleExtract,

−⅛+⅛=0

⅛+⅛=¼

are established, and thus a new TLWE ciphertext cs having either of two values, i.e., 0 or ¼ as a plaintext is obtained.

### (3) KeySwitching

The TLWE ciphertext cs obtained by using SampleExtract in (2) is encrypted with the private key [s′], not with the private key [s].

Therefore, it is necessary to replace the key of the TLWE ciphertext cs with the private key [s] and return the state of the ciphertext to a state where encryption has been performed with the private key [s], without decrypting the TLWE ciphertext cs.

Therefore, a method of KeySwitching is described.

The private key [s] of a TLWE ciphertext used in a NAND operation is an N-th order vector.

By using this vector, the private key [s′] that is an n-th order vector when the Bootstrapping Key has been created is encrypted.

That is, the private key [s′] is encrypted as a value obtained by shifting an element of the circle group {T} to each digit of a real number from 0 to 1 in binary notation, as represented by

s′ᵢ×2⁻¹ s′ᵢ×2⁻² s′ᵢ×2⁻³ . . . .

The private key is [s]. A “number of digits” t is a system parameter.

When decryption is performed with the private key [s],

ϕₛ(KS_{i,j})=s′ᵢ×2^{-j}

is obtained. This is a “KeySwitching key”.

As described above, the TLWE ciphertext cs=([a], b) obtained in (2) is 0 or ¼ obtained by encryption with the private key [s′]. The number of elements of [a] is the same as that of the private key [s′] and is n.

When the elements are converted to t-bit fixed-point numbers one by one, the elements can be written in the following form.

aᵢ≈Σⱼ₌₁^{t}a_{i,j}×2^{-j}

Although an error is increased in this stage, the maximum value of the absolute value can be limited by a system parameter.

As main processing of KeySwitching, the following TLWE ciphertext cx is calculated.

cx=(\vec{0}, b)−Σᵢ₌₁ⁿΣⱼ₌₁^{t}a_{i,j}×KS_{i,j}

Since the term ([0], b) is a trivial ciphertext, this term is b when being decrypted. A result of decryption of the TLWE ciphertext cx is calculated as follows.

ϕₛ(cx)=b−Σᵢ₌₁ⁿΣⱼ₌₁^{t}a_{i,j}×s′ᵢ×2^{-j}=b−Σᵢ₌₁ⁿΣⱼ₌₁^{t}s′ᵢ×a_{i,j}×2^{-j}

Since s′ᵢ is a constant for j, it is factored out as follows.

=b−Σᵢ₌₁ⁿs′ᵢΣⱼ₌₁^{t}a_{i,j}×2^{-j}
The expression obtained by decomposition into fixed-point numbers descried above is then substituted.

≈b−Σᵢ₌₁ⁿs′ᵢ×aᵢ=ϕ_{s′}((\vec{a}, b))=ϕ_{s′}(cₛ)

As a result,

ϕₛ(cx)≈ϕ_{s′}(cₛ)

is obtained. That is, switching of keys is successful.

The TLWE ciphertext cx obtained here is encrypted with the private key [s] that is the same as a private key for the TLWE ciphertext c used as the input of Gate Bootstrapping.

By performing the processing of KeySwitching, the ciphertext returns to the TLWE ciphertext encrypted with the private key [s], so that its plaintext φₛ(cx) is 0 when φₛ(c) is in a range of ±¼, and is ¼ when φₛ(c) is in a range of ½±¼.

By the processing described above, a TLWE ciphertext is obtained as a result of Gate Bootstrapping, which is either of two values, i.e., 0 or ¼ and has any error within ± 1/16.

The maximum value of the error does not depend on the TLWE ciphertext c that is the input, and is a value fixed by a system parameter.

Therefore, the system parameter is set in such a manner that the maximum value of the error is any value within ± 1/16 that is the same range as that for a TLWE ciphertext as the input.

This setting enables a NAND operation to be performed any number of times, and enables any operation including addition and multiplication to be performed.

Examples of an error added to a “plaintext” of a TLWE ciphertext output from Gate Bootstrapping include an error added by converting a TLWE ciphertext to an integer, an error added by CMux, and an error when the TLWE ciphertext is converted to a fixed-point number by KeySwitching. All these errors can be limited by a system parameter, and the system parameter can be adjusted in such a manner that an error for which all things are considered falls within ± 1/16.

The processing described above is processing of Gate Bootstrapping in TFHE.

In the present embodiment, system parameters in TFHE presented in the aforementioned paper are improved in such a manner that the dispersion range of the error is reduced from ± 1/16 to ± 1/24.

According to the present embodiment, three binary inputs can be processed by homomorphic addition performed once. That is, a homomorphic operation can be performed by using three ciphertexts that can take two values as a plaintext as inputs. By performing Gate Bootstrapping for the result of the homomorphic addition, a 3-input logic element can be configured together with a homomorphic operation.

Two logic elements that obtain a lower bit as the sum and a higher bit (a carry), respectively, can be created. The number of times of Gate Bootstrapping, which occupies almost all an operation time of a full adder, can be reduced from five to two. Since the two 3-input logic elements have no dependency with each other, those logic elements can process two arithmetic operations in parallel.

### EXAMPLE 1

The description is made based on FIG. 3.

It is assumed that there are TLWE ciphertexts ca, cb, and cc respectively corresponding to inputs A, B, and C of a full adder.

Each of these ciphertexts is a TLWE ciphertext based on system parameters set specially and is generated by Gate Bootstrapping or newly encrypted.

The TLWE ciphertexts ca, cb, and cc each have 0 or ¼ as a plaintext, and an error added to the plaintext is included in a range of ± 1/24.

By adopting three binary inputs, the error ranges may overlap. For this reason, the error added to the plaintext is set to be smaller than ± 1/16 presented in the aforementioned paper, i.e., within ± 1/24.

However, if an issue caused by overlapping of the error ranges is acceptable, the error is not limited thereto, and ± 1/24 in Examples or ± 1/16 in the aforementioned paper may be adopted as the error, as described later.

The encryption processing apparatus 1 calculates ca+cb+cc-(0, ⅛) to obtain the TLWE ciphertext ct as the operation result. (0, ⅛) is a trivial ciphertext of which a plaintext is ⅛.

The result of the operation ca+cb+cc-(0, ⅛) is as follows.
When ca is 0, cb is 0, and cc is 0 (then ca+cb+cc is expressed with binary symbols as 0+0+0=0)»0+0+0−⅛=−⅛ (⅞).
When ca is 0, cb is 0, and cc is ¼ (then ca+cb+cc is expressed with binary symbols as 0+0+1=1)»0+0+¼−⅛=⅛.
When ca is 0, cb is ¼, and cc is 0 (then ca+cb+cc is expressed with binary symbols as 0+1+0=1)»0+¼+0−⅛=⅛.
When ca is 0, cb is ¼, and cc is ¼ (then ca+cb+cc is expressed with binary symbols as 0+1+1=2)»0+¼+¼−⅛=⅜.
When ca is ¼, cb is 0, and cc is 0 (then ca+cb+cc is expressed with binary symbols as 1+0+0=1)»¼+0+0−⅛=⅛.
When ca is ¼, cb is 0, and cc is ¼ (then ca+cb+cc is expressed with binary symbols as 1+0+1=2)»¼+0+¼−⅛=⅜.
When ca is ¼, cb is ¼, and cc is 0 (then ca+cb+cc is expressed with binary symbols as 1+1+0=2)»¼+¼+0−⅛=⅜.
When ca is ¼, cb is ¼, and cc is ¼ (then ca+cb+cc is expressed with binary symbols as 1+1+1=3)»¼+¼+¼−⅛=⅝.

The TLWE ciphertext ct has any of four values of ⅛, ⅜, ⅝, and ⅞ as the plaintext, and the error added to the plaintext is included in ±⅛.

This is because the errors of the three TLWE ciphertexts ca, cb, and cc, each being ± 1/24, are added together.

The encryption processing apparatus 1 then performs Gate Bootstrapping as described in the aforementioned paper for the TLWE ciphertext ct.

As a result, the TLWE ciphertext cy having 0 as its plaintext when ca+cb+cc is a binary symbol 0 or 1 and having ¼ when ca+cb+cc is a binary symbol 2 or 3. In the TLWE ciphertext cy, the error added to the plaintext is included in a range of ± 1/24. This ciphertext is used as a higher bit of the sum of a full adder (a carry out).

Next, the encryption processing apparatus 1 performs homomorphic addition between the ciphertexts ct. The encryption processing apparatus 1 performs an operation ct+ct+(0, ¼) and performs Gate Bootstrapping as described in the aforementioned paper. The result of an operation ct+ct is the ciphertext cz that takes 0 or ½ as the plaintext and in which the error added to the plaintext is included in a range of ±¼.

The operation result is as follows:
When ca is 0, cb is 0, and cc is 0»−⅛+(−⅛)+¼=0.
When ca is 0, cb is 0, and cc is ¼»⅛+⅛+¼= 4/8=½.
When ca is 0, cb is ¼, and cc is 0»⅛+⅛+¼= 4/8=½.
When ca is 0, cb is ¼, and cc is ¼»⅜+⅜+¼= 8/8=1(0).
When ca is ¼, cb is 0, and cc is 0 »⅛+⅛+¼= 4/8=½.
When ca is ¼, cb is 0, and cc is ¼»⅜+⅜+¼= 8/8=1(0).
When ca is ¼, cb is ¼, and cc is 0»⅜+⅜+¼= 8/8=1(0).
When ca is ¼, cb is ¼, and cc is ¼»⅝+⅝+¼= 12/8= 3/2(½).

As the result of Gate Bootstrapping, the TLWE ciphertext cz is obtained of which the plaintext is 0 when ca+cb+cc is a binary symbol 0 or 2 and ½ when ca+cb+cc is a binary symbol 1 or 3. The error added to the plaintext in the ciphertext cz is included in a range of ± 1/24. This ciphertext is used as a lower bit of the sum of the full adder.

With this configuration, the encryption processing apparatus 1 can reduce the number of Gate Bootstrapping that consumes almost all a computation time in an operation by a logic element to two. As a result of experiment, the computation time was 22.4 ms.

It was confirmed that, as compared with 55.5 ms in a case of performing Gate Bootstrapping five times, the computation time was reduced by 60%. In addition, the two Gate Bootstrapping processes have no dependency with each other. Therefore, the two Gate Bootstrapping processes can be performed in a processing time for one stage of Gate Bootstrapping by parallelizing those processes by using a method such as multithreading.

### EXAMPLE 2

This example is the same as the above example in that, by reducing a range of an error added to a plaintext, a 3-input binary logical operation (an operation performed using three ciphertexts each of which can take two values as a plaintext as inputs) is performed.

In the above example (Example 1), a test vector is as described in the aforementioned paper because the entire circle group {T} (0 to 1) is used for calculation of a lower bit.

In Example 2, a test vector is made special by using only the lower half (0 to 0.5) of the circle group {T} for calculation of a lower bit.

The reason for using only the lower half (0 to 0.5) of the circle group {T} is that a value with inverted sign does not appear in a test vector corresponding to the circle group {T}. This method has an advantage that the 0th order term to the n-th order term of the test vector correspond to ciphertexts in one-to-one correspondence.

In order to prevent overlapping of error ranges in a case of using only the lower half (0 to 0.5) of the circle group {T}, the dispersion range of error for plaintext must be made small (± 1/48) as described below. However, if a problem caused by overlapping of error ranges is acceptable, the dispersion range of error is not limited thereto, as described later. A range of ± 1/24 in examples and a range of ± 1/16 in the aforementioned paper may be adopted as the dispersion range of error.

It is assumed that there are TLWE ciphertexts ca, cb, and cc respectively corresponding to inputs A, B, and C of a full adder.

These ciphertexts are TLWE ciphertexts based on system parameters set specially and are generated by Gate Bootstrapping or newly encrypted.

The TLWE ciphertexts ca, cb, and cc each have 0 or ⅛ as a plaintext, and an error added to the plaintext is included in a range of ± 1/48. As for the TLWE ciphertexts ca, cb, and cc, 0 corresponds to a binary symbol 0, and ⅛ corresponds to a symbol 1.

The encryption processing apparatus 1 calculates ca+cb+cc+(0, 1/16) to obtain the TLWE ciphertext ct as the operation result. (0, 1/16) is a trivial ciphertext of which a plaintext is 1/16.

ca+cb+cc is represented by using binary symbols as follows.
When ca is 0, cb is 0, and cc is 0»0+0+0=0.
When ca is 0, cb is 0, and cc is ⅛»0+0+1=1.
When ca is 0, cb is ⅛, and cc is 0»0+1+0=1.
When ca is 0, cb is ⅛, and cc is ⅛»0+1+1=2.
When ca is ⅛, cb is 0, and cc is 0»1+0+0=1.
When ca is ⅛, cb is 0, and cc is ⅛»1+0+1=2.
When ca is ⅛, cb is ⅛, and cc is 0»1+1+0=2.
When ca is ⅛, cb is ⅛, and cc is ⅛»1+1+1=3.

This also applies to the following description.

The result of the operation ca+cb+cc+(0, 1/16) is as follows.
When ca is 0, cb is 0, and cc is 0»0+0+0+ 1/16= 1/16.
When ca is 0, cb is 0, and cc is ⅛»0+0+⅛+ 1/16= 3/16.
When ca is 0, cb is ⅛, and cc is 0»0+⅛+0+ 1/16= 3/16.
When ca is 0, cb is ⅛, and cc is ⅛»0+⅛+⅛+ 1/16= 5/16.
When ca is ⅛, cb is 0, and cc is 0»⅛+0+0+ 1/16= 3/16.
When ca is ⅛, cb is 0, and cc is ⅛»⅛+0+⅛+ 1/16= 5/16.
When ca is ⅛, cb is ⅛, and cc is 0»⅛+⅛+0+ 1/16= 5/16.
When ca is ⅛, cb is ⅛, and cc is ⅛»⅛+⅛+⅛+ 1/16= 7/16.

The TLWE ciphertext ct has any of four values of 1/16, 3/16, 5/16, and 7/16 as the plaintext, and the error added to the plaintext is included in a range of ± 1/16.

This is because the errors of the three TLWE ciphertexts ca, cb, and cc, each being ± 1/48, are added together.

The encryption processing apparatus 1 then performs Gate Bootstrapping as described in the aforementioned paper for the TLWE ciphertext ct. However, a coefficient μ of a test vector used in BlindRotate is set to 1/16, although that coefficient μ is ⅛ in the aforementioned paper.

As a result, the TLWE ciphertext cy is obtained which has 0 as the plaintext when ca+cb+cc is a symbol 0 or 1 and has ⅛ as the plaintext when ca+cb+cc is a symbol 2 or 3. The error added to the plaintext is included in a range of ± 1/48. This is used as a carry out of a full adder.

Next, the encryption processing apparatus 1 performs Gate Bootstrapping for the TLWE ciphertext ct.

The aforementioned paper uses, as a test vector for BlindRotate,

μXⁿ⁻¹+μXⁿ⁻²+ . . . +μX+μ

where μ=⅛, multiplied by X^{n/2}.

In place of that test vector, the encryption processing apparatus 1 uses, as a test vector,

μ₁Xⁿ⁻¹+μ₁Xⁿ⁻²+ . . . μ₁X^{3n/4}+μ₂X^{3n/4-1} . . . +μ₂X^{n/2}+μ₃X^{n/2-1}+ . . . μ₃X^{n/4}+μ₄X^{n/4-1} . . . +μ₄X+μ₄

where μ₁=μ₃= 1/16 and μ₂=μ₄=− 1/16.

In a stage immediately after SampleExtract, a TLWE ciphertext that can take two values of − 1/16 and 1/16 as a plaintext is obtained.

After that stage, (0, 1/16) is added, and key switching is performed, as in the aforementioned paper. Consequently, the TLWE ciphertext cz is obtained which has 0 as the plaintext when ca+cb+cc is a symbol 0 or 2 and has ⅛ as the plaintext when ca+cb+cc is a symbol 1 or 3. An error added to the plaintext is included in a range of ± 1/48. This ciphertext is output as a lower bit of a sum.

With this configuration, the encryption processing apparatus 1 can reduce the number of Gate Bootstrapping that consumes almost all a computation time in an operation of a logic element to two. As a result of experiment, the computation time was 22.4 ms.

It was confirmed that, as compared with 55.5 ms in a case of performing Gate Bootstrapping five times, the computation time was reduced by 60%.

In addition, the two Gate Bootstrapping processes have no dependency with each other. Therefore, the two Gate Bootstrapping processes can be performed in a processing time for one stage by parallelizing those processes by using a method such as multithreading.

### EXAMPLE 3

FIG. 4 is a detailed explanatory diagram of an operation process of a full adder based on the functional configuration in FIG. 2, in relation to Example 3.

Example 3 is based on the homomorphic operation using three binary inputs described in Examples 1 and 2 and further reduces the number of Gate Bootstrapping to one.

As illustrated in FIG. 4, the encryption processing apparatus 1 of Example 3 inputs the input ciphertexts ca, cb, and cc to the third operation unit 14, performs a homomorphic operation, and inputs the operation result (the ciphertext ct=ca+cb+cc) to the third Bootstrapping unit 17 performing binary Gate Bootstrapping.

Outputs of the third Bootstrapping unit 17 are the ciphertext cy as the carry out Cₒ that can have either of two values 0 and μ as the plaintext, and the ciphertext cz as the output S.

The time required for the homomorphic operation by the third operation unit 14 is insignificant.

Gate Bootstrapping consumes almost all a processing time when processing in a full adder is performed using a homomorphic operation.

The encryption processing apparatus 1 of Example 3 inputs three binary ciphertexts to the third operation unit 14 and improves Gate Bootstrapping, as in Examples 1 and 2, thereby reducing the number of times of homomorphic operation process to one in total.

Consequently, the encryption processing apparatus 1 can reduce the number of times of Gate Bootstrapping that occupies almost all the homomorphic operation process to one in total.

Since Gate Bootstrapping occupies almost all an operation time of the full adder involved in fully homomorphic encryption, the encryption processing apparatus 1 can significantly speed up the operation of the full adder by reducing the number of times of Gate Bootstrapping.

The encryption processing apparatus 1 improves the system parameters in the aforementioned paper, thereby reducing a dispersion range of error from ± 1/16 to ± 1/36 or ± 1/48.

By setting higher order coefficients in a test vector for BlindRotate to 0 and multiplying the result of the homomorphic operation by two types of polynomials, a logic element can be created which obtains a lower bit as the sum and a higher bit (as the carry out) for the result of BlindRotate performed once. Accordingly, the number of times of Gate Bootstrapping that occupies almost all the operation time of the full adder, further the number of times of BlindRotate that occupies a large part of Gate Bootstrapping can be reduced from five to one.

A configuration method is different depending on how to arrange binary plaintexts on the circle group {T}. In the present specification, a method using 0 and ⅙ on the circle group {T} is described as a “six-division version”, and a method using 0 and ⅛ is described as an “eight-division version”.

The “six-division version” corresponds to Example 1 described above, in which system parameters are set in such a manner that an error added to a plaintext is within a range of ± 1/36.

The “eight-division version” corresponds to Example 2 described above, in which system parameters are set in such a manner that an error added to a plaintext is within a range of ± 1/48.

The “six-division version” uses a range of 0 to 0.5+⅙ in a range from 0 to 1 on the circle group {T}, and the “eight-division version” uses the right half (0 to 0.5) of the circle group {T}.

It is assumed that there are TLWE ciphertexts ca, cb, and cc respectively corresponding to inputs A, B, and C of a full adder. In the following description, it is assumed that p=⅙ in the “six-division version”, and p=⅛ in the “eight-division version.

The TLWE ciphertexts ca, cb, and cc each have 0 or p as a plaintext, and an error added to the plaintext is included in a range of ± 1/36 in the “six-division version” and in a range of ± 1/48 in the “eight-division version”.

The encryption processing apparatus 1 (the third operation unit 14) calculates ca+cb+cc+(0, p/2). (0, p/2) is a trivial TLWE ciphertext of which a plaintext is p/2.

The result of the operation ca+cb+cc+(0, p/2) is as follows.
When ca is 0, cb is 0, and cc is 0»0+0+0+p/2=p/2.
When ca is 0, cb is 0, and cc is p»0+0+p+p/2=3p/2.
When ca is 0, cb is p, and cc is 0»0+p+0+p/2=3p/2.
When ca is 0, cb is p, and cc is p»0+p+p+p/2=5p/2.
When ca is p, cb is 0, and cc is 0»p+0+0+p/2=3p/2.
When ca is p, cb is 0, and cc is p»p+0+p+p/2=5p/2.
When ca is p, cb is p, and cc is 0»p+p+0+p/2=5p/2.
When ca is p, cb is p, and cc is p»p+p+p+p/2=7p/2.

The TLWE ciphertext ct is obtained which has any of four values of p/2, 3p/2, 5p/2, and 7p/2 as the plaintext and for which the error added to the plaintext is included in a range of ± 1/12 or ± 1/16.

The encryption processing apparatus 1 (the third Bootstrapping unit 17) performs Gate Bootstrapping in accordance with the aforementioned paper for the TLWE ciphertext ct.

In Gate Bootstrapping, the encryption processing apparatus 1 performs BlindRotate using the following polynomial as a test vector.

μX^{2np-1}+μX^{2np-2}+ . . . +μX+μ

where μ=p/2.

This test vector is a polynomial having a value in only one of sections obtained by dividing the circle group {T}.

As a result of BlindRotate, the encryption processing apparatus 1 (the third Bootstrapping unit 17) obtains a TRLWE ciphertext cr=(a(X), b(X)).

Next, the encryption processing apparatus 1 performs multiplication by polynomials fc(X) and fs(X) that are not present in the aforementioned paper, for the TRLWE ciphertext cr.

It is assumed that

fc(X)=X^{4np}−X^{2np}−1

fs(X)=−X^{4np}+X^{2np}−1

in the “six-division version” and

fc(X)=X^{6np}+X^{4np}−X^{2np}−1

fs(X)=X^{6np}−X^{4np}+X^{2np}−1

in the “eight-division version”.

As a result of multiplication of the TRLWE ciphertext cr by the polynomials fc(X) and fs(X), the encryption processing apparatus 1 obtains a TRLWE ciphertext cco and a TRLWE ciphertext cs.

The TRLWE ciphertext cco is a TRLWE ciphertext corresponding to a carry out of a full adder, and the TRLWE ciphertext cs is a TRLWE ciphertext corresponding to the sum output of the full adder.

The TRLWE ciphertexts cco and cs obtained by multiplying the TRLWE ciphertext cr=(a(X), b(X)) by the polynomials fc(X) and fs(X), respectively, are calculated as follows.

cco=(a(X)·fc(X), b(X)·fc(X))

cs=(a(X)·fs(X), b(X)·fs(X))

A plaintext polynomial obtained by decrypting the TRLWE ciphertext cr is

φ_{s′}(cr)=a(X)·s′(X)−b(X)

Therefore, when the TRLWE ciphertext cco is decrypted,

φ_{s′}(cco)=a(X)·fc(X)·s′(X)−b(X)·fc(X)=φ_{s′}(cr)·fc(X)

is obtained, which is the result of multiplication of the plaintext polynomial obtained by decrypting the TRLWE ciphertext cr by the polynomial fc(X).

Similarly to the TRLWE ciphertext cs corresponding to the sum output, when this ciphertext is decrypted,

φ_{s′}(cs)=a(X)·fs(X)·s′(X)−b(X)·fs(X)=φ_{s′}(cr)·fs(X)

is obtained, which is the result of multiplication of the plaintext polynomial obtained by decrypting the TRLWE ciphertext cr by the polynomial fs(X).

BlindRotate is an operation for obtaining, for a test vector polynomial T(X), a TRLWE ciphertext having T(X)·X^{-pt} as a plaintext polynomial without calculating a plaintext pt=φₛ(2n×ct) of a TLWE ciphertext of 2n×ct.

Therefore, a plaintext polynomial obtained by decrypting the TRLWE ciphertext cco is

φ_{s′}(cco)=T(X)·X^{-pt}·fc(X)

and is the same as a polynomial obtained when T(X)·fc(X) is used as a test vector polynomial.

Similarly, a plaintext polynomial obtained by decrypting the ciphertext cs is

φ_{s′}(cs)=T(X)·X^{-pt}·fs(X)

and is the same as a polynomial obtained when T(X)·fs(X) is used as a test vector.

The polynomials fc(X) and fs(X) in the “six-division version” are expressions by which a test vector is multiplied, whereby test vector polynomials using a range of 0 to 0.5+⅙ on the circle group {T} can be obtained.

The polynomials fc(X) and fs(X) in the “eight-division version” are expressions by which a test vector is multiplied to provide test vector polynomials for using the right half (0 to 0.5) of the circle group { T}.

The encryption processing apparatus 1 factorizes the test vector polynomial (T(X)·fc(X))for obtaining the carry out and the test vector polynomial (T(X)·fs(X)) for obtaining the sum and performs BlindRotate for a common polynomial T(X) obtained as a result of factorization.

The encryption processing apparatus 1 then multiplies the result of BlindRotate by the remaining part of each of the test vector polynomials fc(X) and fs(X).

Thus, both calculation results of the carry out and the sum output are obtained at the same time without performing BlindRotate separately for each of the test vector polynomial for obtaining the carry out and the test vector polynomial for obtaining the sum output.

The results of BlindRotate for two types of polynomials are obtained by performing BlindRotate once.

This fact is equivalent to the fact that two times of Gate Bootstrapping are substantially performed in a time for one, because BlindRotate occupies a large part of a processing time of Gate Bootstrapping.

Next, the encryption processing apparatus 1 performs SampleExtract and key switching for each of cco and cs, as with Gate Bootstrapping in the aforementioned paper. Since these processes consume very little of the processing time of Gate Bootstrapping, the influence on the computation time is small.

Since the above-described configuration is employed, the number of times of BlindRotate that consumes almost all a computation time in an operation in a logic element can be reduced from five to one.

According to experiment, it was confirmed that a computation time in the configuration in Example 3 was 11.4 ms and about five times faster than 55.5 ms in a case of performing Gate Bootstrapping five times.

### EXAMPLE 4

As a modification of Example 3, a process of making the number of times of BlindRotate only one may be performed in the Gate Bootstrapping process for the TLWE ciphertext ct.

The encryption processing apparatus 1 arranges different coefficients between even order terms and odd order terms in a test vector polynomial and makes all coefficients in a TLWE ciphertext even. The encryption processing apparatus 1 thus refers to a plurality of Look Up Tables by BlindRotate performed once, as described below. As a result, the encryption processing apparatus 1 can obtain a plurality of types of operation results for obtaining the ciphertext cz having the sum (the output S) of a full adder as the plaintext and the ciphertext cy having the carry out Cₒ of the full adder as the plaintext by SampleExtract performed thereafter.

The encryption processing apparatus 1 performs calculation for making elements (a plurality of values) of a TLWE ciphertext as a homomorphic operation result integers. The integers are all the same in the reminder of division by 2 (a value of mod 2), and the test vector polynomial has the same coefficients for every other order (every even order or every odd order), thereby being able to obtain a plurality of types of operation results.

It is assumed that there are TLWE ciphertexts ca, cb, and cc respectively corresponding to inputs A, B, and C of a full adder.

The TLWE ciphertexts ca, cb, and cc each have 0 or p as the plaintext as in Example 3, and p is set to ⅙ in the “six-division version” and ⅛ in the “eight-division version”. An error added to the plaintext is included in a range of ± 1/36 in the “six-division version” and in a range of ± 1/48 in the “eight-division version”.

A method of using 0 and ⅙ on the circle group {T} as the plaintext that can take two values is the “six-division version”, and a method of using 0 and ⅛ is the “eight-division version”.

The processes until the encryption processing apparatus 1 (the third operation unit 14) calculates ca+cb+cc+(0, p/2) to obtain the TLWE ciphertext ct that has any of four values including p/2, 3p/2, 5p/2, and 7p/2 as the plaintext and in which an error added to the plaintext is included in a range of ± 1/12 or ± 1/16 are the same as those in Example 3.

As a first step in Example 4, the encryption processing apparatus 1 (the third operation unit 14) multiplies the TLWE ciphertext ct by n, rounds off the multiplication result, and doubles the result of rounding off, thereby obtaining an LWE ciphertext ct1. In the aforementioned paper, the TLWE ciphertext is multiplied by 2n and is then rounded off. The present embodiment is different from the aforementioned paper in this point.

All coefficients in the LWE ciphertext ct1 obtained by the doubling operation are even numbers, and it is guaranteed that a corresponding plaintext p′=φₛ(ct1)=[s]·[a]−b(b−[s]·[a]) decrypted from the LWE ciphertext ct1 becomes an even number. As described regarding the aforementioned paper, the plaintext p′=φₛ(ct1) is the number of times of multiplication of the test vector polynomial T(X) by X, and therefore the rotation number (the number of times of multiplication by X) in BlindRotate is an even number.

Next, the encryption processing apparatus 1 (the third Bootstrapping unit 17) configures a test vector by using

ft(X)=μX^{2np-2}+μX^{2np-4}+ . . . +μX²+μ

where μ=p/2, and performs the Gate Bootstrapping process following the aforementioned paper for the LWE ciphertext ct1. A method of configuring the test vector is described below.

Since 0 to 1 on the circle group {T} of the plaintext corresponds to 0th order to 2n-th order terms in the test vector, a constant term of a plaintext polynomial of a TRLWE ciphertext obtained by performing BlindRotate for a test vector ft(X) is p/2 only when the TLWE ciphertext ct is in a section from 0 to p and 0 otherwise. Further, only even order terms are present in the plaintext polynomial of the TRLWE ciphertext obtained by performing BlindRotate for the test vector ft(X).

In Example 4, ft(X){fc(X)X+fs(X)} obtained by applying, to that test vector ft(X),

fc(X)=X^{4np}−X^{2np}−1

fs(X)=−X^{4np}+X^{2np}−1

in the “six-division version” and

fc(X)=X^{6np}+X^{4np}−X^{2np}−1

fs(X)=X^{6np}−X^{4np}+X^{2np}−1

in the “eight-division version” is set as the test vector polynomial T(X) for BlindRotate.

As described in Example 3, the polynomials fc(X) and fs(X) in the “six-division version” are expressions by which the test vector ft(X) is multiplied to provide test vector polynomials using a range from 0 to 0.5+⅙ on the circle group {T}. Further, the polynomials fc(X) and fs(X) in the “eight-division version” are expressions by which the test vector ft(X) is multiplied to provide test vector polynomials for using the right half (0 to 0.5) of the circle group {T}.

For example, in a case of the “six-division version”,

$$fc ( X ) X + fs ( X ) = ( {X}^{4 np} - {X}^{2 np} - 1 ) X + ( - {X}^{4 np} + {X}^{2 np} - 1 ) = ( {X}^{4 np + 1} - {X}^{2 np + 1} - X ) + ( - {X}^{4 np} + {X}^{2 np} - 1 ) = {X}^{4 np + 1} - {X}^{4 np} - {X}^{2 np + 1} + {X}^{2 np} - X - 1.$$

The test vector polynomial T(X) is as follows.

$$T ( X ) = ft ( X ) \{ fc ( X ) X + fs ( X ) \} = ( μ {X}^{2 np - 2} + μ {X}^{2 np - 4} + … + μ {X}^{2} + μ ) \times ( {X}^{4 np + 1} - {X}^{4 np} - {X}^{2 np + 1} + {X}^{2 np} - X - 1 ) = μ {X}^{6 np - 1} - μ {X}^{6 np - 2} - μ {X}^{4 np - 1} + μ {X}^{4 np - 2} - μ {X}^{2 np - 1} - μ {X}^{2 np - 2} + μ {X}^{6 np - 3} - μ {X}^{6 np - 4} - μ {X}^{4 np - 3} + μ {X}^{4 np - 4} - μ {X}^{2 np - 3} - μ {X}^{2 np - 4} … + μ {X}^{4 np + 3} - μ {X}^{4 np + 2} - μ {X}^{2 np + 3} + μ {X}^{2 np + 2} - μ {X}^{3} - μ {X}^{2} + μ {X}^{4 np + 1} - μ {X}^{4 np} - μ {X}^{2 np + 1} + μ {X}^{2 np} - μ X - μ = μ {X}^{6 np - 1} - μ {X}^{6 np - 2} + μ {X}^{6 np - 3} - μ {X}^{6 np - 4} … + μ {X}^{4 np + 3} - μ {X}^{4 np + 2} + μ {X}^{4 np + 1} - μ {X}^{4 np} - μ {X}^{4 np - 1} + μ {X}^{4 np - 2} - μ {X}^{4 np - 3} + μ {X}^{4 np - 4} - μ {X}^{2 np + 3} + μ {X}^{2 np + 2} - μ {X}^{2 np + 1} + μ {X}^{2 np} - μ {X}^{2 np - 1} - μ {X}^{2 mp - 2} - μ {X}^{2 np - 3} - μ {X}^{2 np - 4} - μ {X}^{3} - μ {X}^{2} - μ X - μ$$

The encryption processing apparatus 1 performs SampleExtract for the result of BlindRotate performed using that test vector polynomial T(X) on the 0th order and the first order.

As a result of making all the coefficients in the TLWE ciphertext ct even numbers by the above-described processes, the number of rotation by BlindRotate (multiplication of the test vector polynomial by X) is an even number.

Therefore, the relation between the coefficients in the test vector polynomial T(X) and parties of the orders is preserved before and after BlindRotate. A coefficient of the even order term in the test vector polynomial T(X) before BlindRotate appears for the 0th order after BlindRotate, and a coefficient of the odd order term in the test vector polynomial T(X) before BlindRotate appears for the first order after BlindRotate. At this time, the signs of the coefficients are inverted.

In the test vector polynomial T(X) after BlindRotate, the ciphertext cz obtained as a result of SampleExtract on the 0th order has the sum (the output S) of a full adder as its plaintext, and the ciphertext cy obtained as a result of SampleExtract on the first order has the carry out Cₒ of the full adder as its plaintext.

Although both the coefficient for the 4np-th order (where 4np is an even number) and the coefficient for the (4np−1)-th order (where 4np−1 is an odd number) in the above-described text vector polynomial T(X) have negative sign, the largest order in the test vector polynomial T(X) is an odd number, and the coefficients the same as those of the even-order term and the odd-order term do not appear for the 0-th order and the first order when rotation by BlindRotate is performed an even number of times. That is, as a result of BlindRotate, values with inverted sign, i.e., positive sign do not appear for both the 0-th order and the first order.

According to the above processes, it is not necessary to perform BlindRotate for each of a test vector polynomial for obtaining the carry out Cₒ and a test vector polynomial for obtaining a test vector that becomes the sum output S. By performing SampleExtract twice on the 0-th order and the first order for the result of BlindRotate performed once for one test vector polynomial, ciphertexts corresponding to two values of a full adder can be obtained.

Since BlindRotate occupies a large part of a processing time of Gate Bootstrapping, the processes in this example are substantially equivalent to performing Gate Bootstrapping twice in a time for performing it once.

Next, the encryption processing apparatus 1 performs key switching in an identical manner to that in Gate Bootstrapping described in the aforementioned paper. These processes only consume a small part of the processing time of Gate Bootstrapping, and therefore the influence on a computation time is insignificant.

Since the encryption processing apparatus 1 is configured in the above-described manner, the number of times of BlindRotate that consumes almost all a computation time in an operation of a logic element can be reduced from five to one.

FIG. 7 is a flowchart for explaining a processing flow of an operation process by a full adder performed by an encryption processing apparatus (Part 1).

As described above, in a case of performing Gate Bootstrapping for a binary ciphertext in the manner described in the paper, a plaintext in a section from 0 to ¼ or ¾ to 1 on the circle group {T} is converted to a TLWE ciphertext of 0, and a plaintext in a section from ¼ to ¾ on the circle group {T} is converted to a TLWE ciphertext of ¼. In Examples 1 and 2, an error added to the plaintext in this conversion is any value in a range of ± 1/24 or ± 1/48 in the present embodiment.

The above-described range on the circle group {T} is made to correspond to symbols used in a (multi-value) logical operation, such as 0 and 1.

The range on the circle group {T} (including the error) corresponds to the symbol of the plaintext in the ciphertext.

The ciphertext is a vector with a format of ([a], b), and the vector element is a point on the circle group. The plaintext is also a point on the circle group {T}.

A symbol used in a logical operation is made to correspond to a range on the circle group {T}, and a plaintext for a certain ciphertext indicates any one point within that range. It is difficult to identify which point in that range is indicated by the plaintext without a private key. The strength of a TLWE ciphertext is thus guaranteed. If a point on the circle group and a symbol are made to correspond to each other with the range set to 0, the plaintext can be derived by collecting a plurality of ciphertexts and using them as simultaneous equations, and therefore the TLWE ciphertext no longer has a function of encryption.

In association with Examples 1 and 2, the encryption processing apparatus 1 (the receiving unit 11) determines whether a ciphertext as an operation object has been input at Step S101.

When it is determined that the ciphertext has been input (Yes at Step S101), the encryption processing apparatus 1 (the receiving unit 11) receives the ciphertext and stores it in the storage unit 20 at Step S102.

The encryption processing apparatus 1 (the first operation unit 12) then performs a homomorphic operation by using the ciphertext and stores the operation result in the storage unit 20 at Step S103.

The encryption processing apparatus 1 (the first calculation unit 15) performs Gate Bootstrapping for the operation result to calculate a ciphertext of a carry out of a full adder, which has either of two values as the plaintext, and stores it in the storage unit 20 at Step S104.

The following operation is performed in the processes by the first operation unit 12 and the first calculation unit 15.

This operation receives input of the three ciphertexts ca, cb, and cc each of which has either of two values as the plaintext, calculates the TLWE ciphertext ct from ca+cb+cc−⅛, and performs Gate Bootstrapping for the TLWE ciphertext ct to obtain the cyphertext cy as the carry out Cₒ.

For example, when each of the three input ciphertexts is a binary symbol 0 or 1, that is, in a section of 0± 1/24 or ¼± 1/24, and the first operation unit 12 performs the operation at Step S103, the ciphertext ct is obtained by the following operation.
When ca is 0, cb is 0, and cc is 0»0± 1/24+0± 1/24+0± 1/24−⅛=−⅛±⅛
When ca is 0, cb is 0, and cc is 1»0± 1/24+0± 1/24+¼± 1/24−⅛=⅛±⅛
When ca is 0, cb is 1, and cc is 0»0± 1/24+¼± 1/24+0± 1/24−⅛=⅛±⅛
When ca is 0, cb is 1, and cc is ¼»0± 1/24+¼± 1/24+¼± 1/24−⅛=⅜±⅛
When ca is 1, cb is 0, and cc is 0»¼± 1/24+0± 1/24+0± 1/24−⅛=⅛±⅛
When ca is ¼, cb is 0, and cc is 1»¼± 1/24+0± 1/24+¼± 1/24−⅛=⅜±⅛
When ca is 1, cb is 1, and cc is 0»¼± 1/24+0± 1/24+¼± 1/24−⅛=⅜±⅛
When ca is 1, cb is 1, and cc is 1»¼± 1/24+¼± 1/24+¼± 1/24−⅛=⅝±⅛

The ciphertext ct thus obtained has any of four values including ⅛, ⅜, ⅝, and ⅞ as the plaintext, and the error added to the plaintext falls within a range of ±⅛.

When the first calculation unit 15 performs Gate Bootstrapping for the TLWE ciphertext ct as a process at Step S104, the ciphertext cy is output which has 0 or ¼ as the plaintext and in which the error added to the plaintext falls within a range of ± 1/24. This output is used as a higher bit (the carry out Cₒ) of the sum of the full adder.

The encryption processing apparatus 1 (the second operation unit 13) performs a homomorphic operation between the temporary ciphertexts cy obtained at Step S103 and stores the operation result in the storage unit 20 at Step S105.

The encryption processing apparatus 1 (the second calculation unit 16) performs binary Gate Bootstrapping for the result of the operation at Step S105 to calculate the output ciphertext cz and stores it in the storage unit 20 at Step S106.

The following operation is performed as a result of the processes by the second operation unit 13 and the second calculation unit 16.

This operation receives input of the ciphertext ct that has either of two values as the plaintext and adds the ciphertexts ct together to obtain the output ciphertext cz having either one of two values as the plaintext.

When the second operation unit 13 performs the operation at Step S105, the following operation is performed.
When ca is 0, cb is 0, and cc is 0»−⅛±⅛+(−⅛±⅛)+¼=0±¼
When ca is 0, cb is 0, and cc is ¼»⅛±⅛+⅛±⅛+¼= 4/8±¼=½±¼
When ca is 0, cb is ¼, and cc is 0»⅛±⅛+⅛±⅛+¼= 4/8±¼=½±¼
When ca is 0, cb is ¼, and cc is ¼»⅜±⅛+⅜±⅛+¼= 8/8±¼=1(0)±¼
When ca is ¼, cb is 0, and cc is 0»⅛±⅛+⅛±⅛+¼= 4/8±¼=½±¼
When ca is ¼, cb is 0, and cc is ¼»⅜±⅛+⅜±⅛+¼= 8/8±¼=1(0)±¼
When ca is ¼, cb is ¼, and cc is 0»⅜±⅛+⅜±⅛+¼= 8/8±¼=1(0)±¼
When ca is ¼, cb is ¼, and cc is ¼»⅝±⅛+⅝±⅛+¼= 12/8±¼= 3/2(½)±¼

When the second calculation unit 16 performs Gate Bootstrapping as the process at Step S106, the ciphertext cz that has 0 or ¼ as the plaintext and in which the error added to the plaintext falls within a range of ± 1/24 is obtained. This ciphertext is used as a lower bit (the output S) of the sum of the full adder.

The binary Gate Bootstrapping at Step S104 and the binary Gate Bootstrapping at Step S106 can be performed in parallel by multithreading.

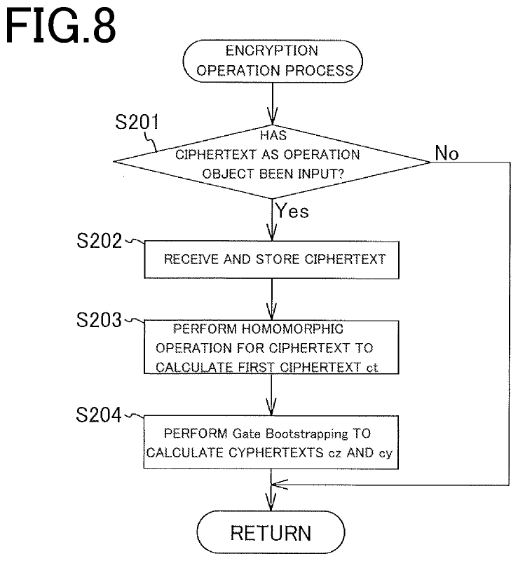

FIG. 8 is a flowchart for explaining a process flow of an operation process by a full adder performed by an encryption processing apparatus (Part 2).

The following description applies to Examples 3 and 4 in the “eight-division version”.

The encryption processing apparatus 1 (the receiving unit 11) determines whether a ciphertext as an operation object has been input at Step S201.

When it is determined that the ciphertext has been input (Yes at Step S201), the encryption processing apparatus 1 (the receiving unit 11) receives the ciphertext and stores it in the storage unit 20 at Step S202.

The encryption processing apparatus 1 (the third operation unit 14) then performs a homomorphic operation by using the ciphertext and stores the operation result in the storage unit 20 at Step S203.

The encryption processing apparatus 1 (the third calculation unit 17) performs Gate Bootstrapping for the operation result to calculate a ciphertext of the carry out Cₒ of a full adder, which has either of two values as the plaintext, and stores it in the storage unit 20 at Step S204.

The following operation is performed in the processes by the third operation unit 14 and the third calculation unit 17.

This operation receives input of the three ciphertexts ca, cb, and cc each having either of two values as the plaintext, calculates the TLWE ciphertext ct from ca+cb+cc+ 1/16, and performs Gate Bootstrapping for the TLWE ciphertext ct to obtain the cyphertext cy as the carry out Cₒ (a higher bit) and the ciphertext cz as the output S of the full adder.

For example, when each of the three input ciphertexts is a binary symbol 0 or 1, that is, in a section of 0± 1/48 or 1/8± 1/48, and the third operation unit 14 performs the operation at Step S203, the following operation is performed.
When ca is 0, cb is 0, and cc is 0»0± 1/48+0± 1/48+0± 1/48+ 1/16= 1/16± 1/16
When ca is 0, cb is 0, and cc is 1»0± 1/48+0± 1/48+⅛± 1/48+ 1/16= 3/16± 1/16
When ca is 0, cb is 1, and cc is 0»0± 1/48+⅛± 1/48+0± 1/48+ 1/16= 3/16± 1/16
When ca is 0, cb is 1, and cc is ¼»0± 1/48+⅛± 1/48+⅛± 1/48+ 1/16= 3/16± 1/16
When ca is 1, cb is 0, and cc is 0»⅛± 1/48+0± 1/48+0± 1/48+ 1/16= 3/16± 1/16
When ca is 1, cb is 0, and cc is 1»⅛± 1/48+0± 1/48+⅛± 1/48+ 1/16= 5/16± 1/16
When ca is 1, cb is 1, and cc is 0»⅛± 1/48+⅛± 1/48+0± 1/48+ 1/16= 5/16± 1/16
When ca is 1, cb is 1, and cc is 1»⅛± 1/48+⅛± 1/48+⅛± 1/48+ 1/16= 7/16± 1/16

The ciphertext ct thus obtained has any of four values including 1/16, 3/16, 5/16, and 7/16 as the plaintext, and the error added to the plaintext falls within a range of ± 1/16.

When the third calculation unit 17 performs Gate Bootstrapping as the process at Step S204, the ciphertexts cy and cz are output each of which has 0 or ⅛ as the plaintext and in which the error added to the plaintext falls within a range of ± 1/48. These ciphertexts are used as a lower bit (the output S) of the sum of a full adder and a higher bit (the carry out Cₒ) of the sum of the full adder.

### Modification

In the “six-division version” of Example 3 described above, parameters are changed in such a manner that a value of a plaintext is set to 0 or ⅙ and an error added to the plaintext falls within a range of ± 1/36, so as to correspond to Example 1, thereby further reducing the number of times of Gate Bootstrapping to one.

The ciphertext cz as the sum of a full adder and the ciphertext cy as the carry out can be obtained also by using the same parameters as those in the “six-division version” of Example 3, setting the error added to the plaintext within a range of ± 1/36, and performing Gate Bootstrapping twice with two different test vector polynomials each having either of two values, i.e., 0 or ⅙ as the plaintext.

In Modification, the encryption processing apparatus 1 calculates ca+cb+cc+ 1/12 to obtain a TLWE ciphertext ct′ as the calculation result.

In Example 1, the ciphertext cy as the carry out Cₒ has been calculated by performing Gate Bootstrapping in the manner described in the aforementioned paper for the TLWE ciphertext ct, and the ciphertext cz as the output S has been calculated by performing Gate Bootstrapping in the manner described in the aforementioned paper for the result of the homomorphic operation (ct+ct) between the TLWE ciphertexts ct, as described above.

Meanwhile, in Modification, Gate Bootstrapping is performed for the TLWE ciphertext ct′ by using two different test vector polynomials TA and TB, whereby the ciphertext cy and the ciphertext cz are obtained.

The test vector polynomial TA for obtaining the ciphertext cy as the carry out Cₒ is defined as follows.

μ1Xⁿ⁻¹+ . . . +μ1X^{2n/3}+μ2X^{2n/3-1}+ . . . +μ2X⁰

where μ= 1/12 and μ2=− 1/12.

In order to obtain the ciphertext cz as the output S, the test vector polynomial TB is defined as follows.

μ1Xⁿ⁻¹+ . . . +μ1X^{2n/3}+μ2X^{2n/3-1}+ . . . +μ2X^{n/3}+μ1X^{n/3-1}+ . . . +μ1X⁰

where μ1=− 1/12 and μ2= 1/12.

The homomorphic operation (ct′+ct′) between the TLWE ciphertexts ct′ is not performed. Instead, Gate Bootstrapping using the test vector polynomial TB is performed for the TLWE ciphertext ct′, whereby the ciphertext cz can be obtained.

When each of the three input ciphertexts is a binary symbol 0 or 1, that is, in a section of 0± 1/36 or ⅙± 1/36, the result of an operation ca+cb+cc+ 1/12 by the first operation unit 12 is as follows.
When ca is 0, cb is 0, and cc is 0 (ca+cb+cc is expressed with binary symbols as 0+0+0=0)»0+0+0+ 1/12= 1/12
When ca is 0, cb is 0, and cc is ⅙ (ca+cb+cc is expressed with binary symbols as 0+0+1=1)»0+0+⅙+ 1/12=¼( 3/12)
When ca is 0, cb is ⅙, and cc is 0 (ca+cb+cc is expressed with binary symbols as 0+1+0=1)»0+⅙+0+ 1/12=¼( 3/12)
When ca is 0, cb is ⅙, and cc is ⅙ (ca+cb+cc is expressed with binary symbols as 0+1+1=2)»0+⅙+⅙+ 1/12= 5/12
When ca is ⅙, cb is 0, and cc is 0 (ca+cb+cc is expressed with binary symbols as 1+0+0=1)»⅙+0+0+ 1/12=¼( 3/12)
When ca is ⅙, cb is 0, and cc is ⅙ (ca+cb+cc is expressed with binary symbols as 1+0+1=2)»⅙+0+⅙+ 1/12= 5/12
When ca is ⅙, cb is ⅙, and cc is 0 (ca+cb+cc is expressed with binary symbols as 1+1+0=2)»⅙+⅙+0+ 1/12= 5/12
When ca is ⅙, cb is ⅙, and cc is ⅙ (ca+cb+cc is expressed with binary symbols as 1+1+1=3)»⅙+⅙+⅙+ 1/12= 7/12

The ciphertext that is the operation result has 1/12, ¼, 5/12, or 7/12 as the plaintext.

In Gate Bootstrapping by the first Bootstrapping unit 15, only when ca, cb, and cc are all a binary symbol 1, the operation result of ca+cb+cc becomes a binary symbol 3 and corresponds to the left half (the upper half of the circle group {T}).

On the upper half (0.5 to 1) of the circle group {T}, the signs of coefficients of lower terms X^{n/3-1} to . . . X⁰ in a test vector polynomial are inverted to negative sign.

Therefore, the coefficient of lower terms μ2X^{n/3-1} to μ2X⁰ in the test vector polynomial TA is 1/12 obtained by multiplying μ2=− 1/12 by −1. (0, 1/12) is added to this coefficient value, whereby ⅙ is obtained as the plaintext of the ciphertext cy as the carry out Cₒ. (0, 1/12) is a trivial ciphertext having 1/12 as the plaintext.

Further, the coefficient of lower terms μ1X^{n/3-1} to μ1X⁰ in the test vector polynomial TB is 1/12 obtained by multiplying μ1=− 1/12 by −1. (0, 1/12) is added to this coefficient value, whereby ⅙ is obtained as the plaintext of the ciphertext cz as the sum (the output S) of a full adder.

Both the obtained ciphertexts cy and cz have 0 or ⅙ as the plaintext, and it is found that the carry out Cₒ and the sum (the output S) of a full adder have been calculated correctly.

### Application to AOI21 and OAI21 Gates

A technique identical to Modification related to a full adder described above can be applied to an AOI21 gate and an OAI21 gate to increase the speed.

The AOI21 gate is abbreviation of AND-OR-INVERT2-1 gate and outputs D1=NOT(OR(A, AND(B, C))) for inputs A, B, and C. In the following description, the AOI21 gate is simply described as an AOI gate.

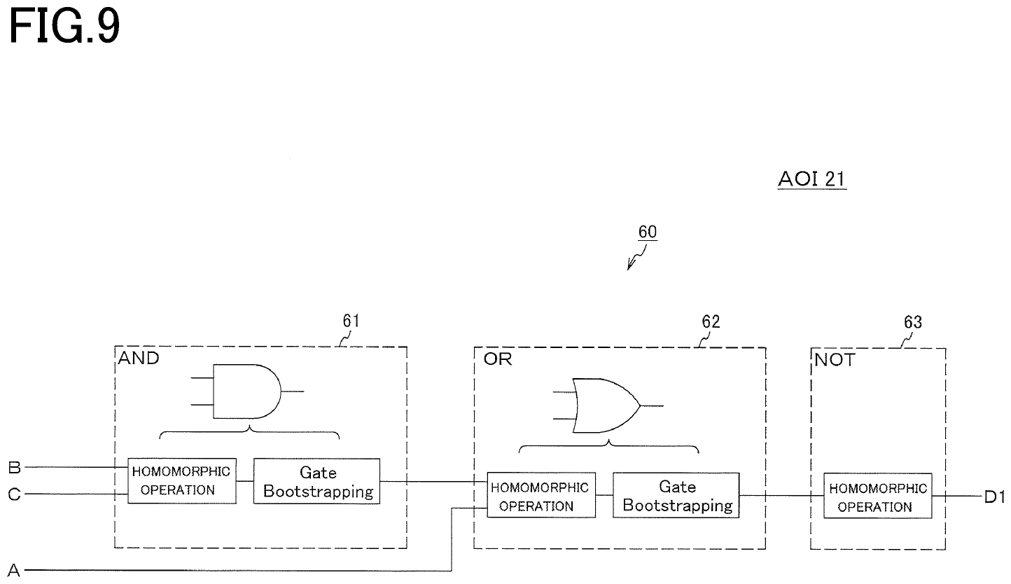

FIG. 9 is a diagram illustrating a configuration example of an AOI gate.

FIG. 9 illustrates the AOI gate as a hardware circuit configured by logical operators but may be considered as an AOI gate program executed by a CPU that implements the AOI gate by software.

When processing of Bit-wise type homomorphic encryption is implemented by software, an operation is performed to imagine designing a logic circuit (a logic gate) for a ciphertext.

An AOI gate 60 includes one AND circuit unit (an operation processing unit for obtaining AND) 61 and one OR circuit unit (an operation processing unit for obtaining OR) 62.

The AND circuit unit 61 and the OR circuit unit 62 each include an operation unit performing a homomorphic operation between ciphertexts and a calculation unit performing Gate Bootstrapping that reduces the error of the operation result.

The input B and the input C are input to the AND circuit unit 61, the output of the AND circuit unit 61 and the input A are input to the OR circuit unit 62 provided in the subsequent stage, and the AOI output D1 is output from the OR circuit unit 62.

The AOI gate has the following Boolean values.

| A | B | C | D1 |
|---|---|---|---|
| 0 | 0 | 0 | 1 |
| 0 | 0 | 1 | 1 |
| 0 | 1 | 0 | 1 |
| 0 | 1 | 1 | 0 |
| 1 | 0 | 0 | 0 |
| 1 | 0 | 1 | 0 |
| 1 | 1 | 0 | 0 |
| 1 | 1 | 1 | 0 |

Meanwhile, the OAI21 gate is abbreviation of OR-AND-INVERT2-1 gate and outputs D2=NOT(AND(A, OR(B, C))) for the inputs A, B, and C. In the following description, the OAI21 gate is simply described as an OAI gate.

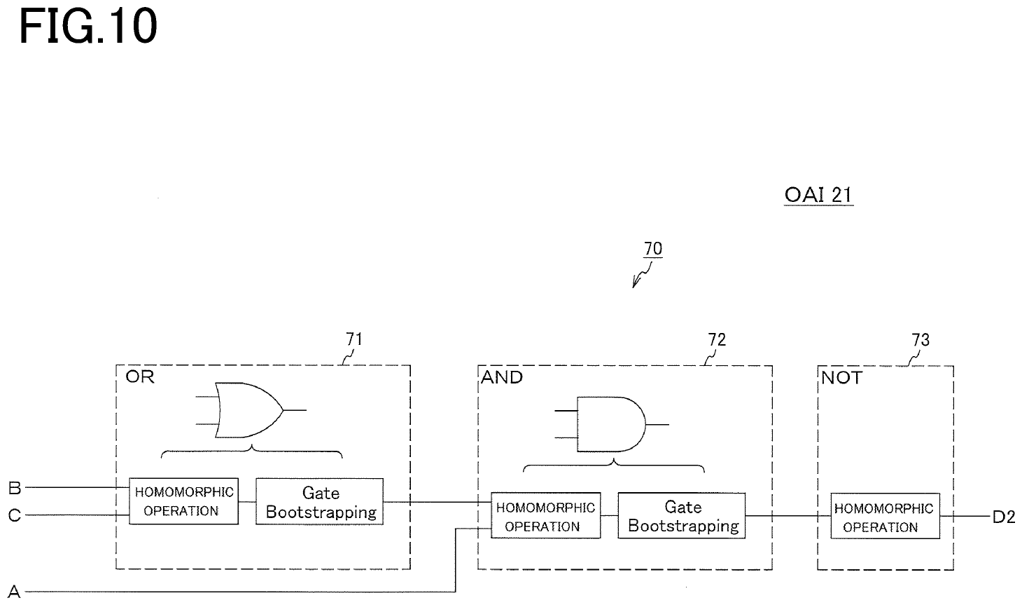

FIG. 10 is a diagram illustrating a configuration example of an OAI gate.

FIG. 10 illustrates the OAI gate as a hardware circuit configured by logical operators but may be considered as an OAI gate program executed by a CPU that implements the OAI gate by software.

When processing of Bit-wise type homomorphic encryption is implemented by software, an operation is performed to imagine designing a logic circuit (a logic gate) for a ciphertext.

An OAI gate 70 includes one OR circuit unit (an operation processing unit for obtaining OR) 71 and one AND circuit unit (an operation processing unit for obtaining AND) 72.

The OR circuit unit 71 and the AND circuit unit 72 each include an operation unit performing a homomorphic operation between ciphertexts and a calculation unit performing Gate Bootstrapping that reduces the error of the operation result.

The input B and the input C are input to the OR circuit unit 71, the output of the OR circuit unit 71 and the input A are input to the AND circuit unit 72 provided in the subsequent stage, and the OAI output D2 is output from the AND circuit unit 72.

The OAI gate has the following Boolean values.

| A | B | C | D2 |
|---|---|---|---|
| 0 | 0 | 0 | 1 |
| 0 | 0 | 1 | 1 |
| 0 | 1 | 0 | 1 |
| 0 | 1 | 1 | 1 |
| 1 | 0 | 0 | 1 |
| 1 | 0 | 1 | 0 |
| 1 | 1 | 0 | 0 |
| 1 | 1 | 1 | 0 |

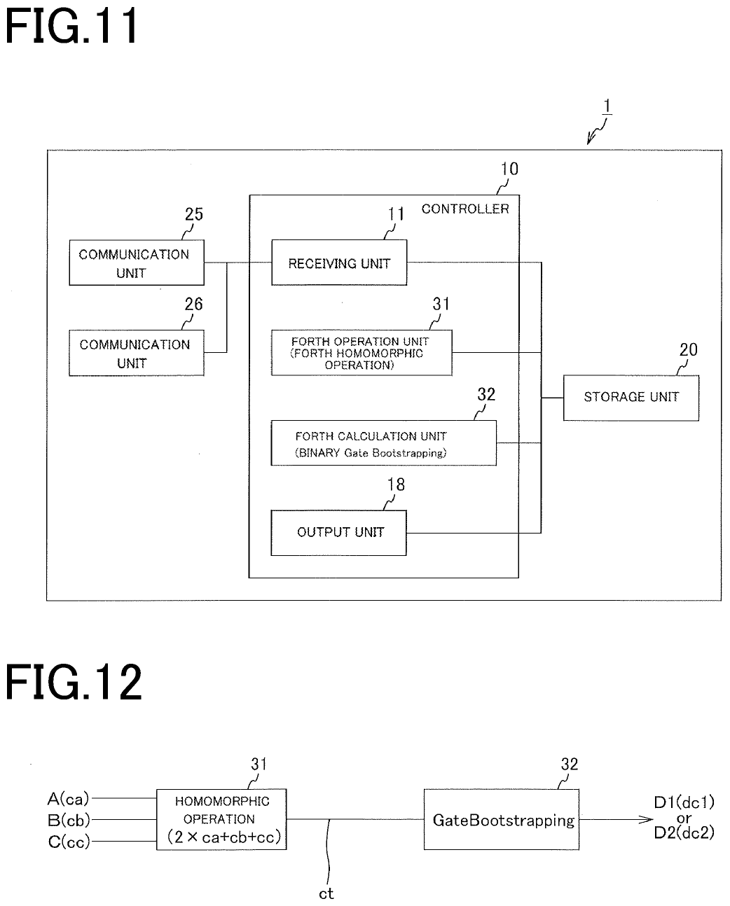

FIG. 11 is an explanatory diagram of a functional configuration of an encryption processing apparatus that implements an AOI gate and an OAI gate.

The encryption processing apparatus 1 includes the control unit 10, the storage unit 20, the communication unit 25, and the input unit 26.

The control unit 10 includes the receiving unit 11, a fourth operation unit 31, a fourth Bootstrapping unit (a fourth calculation unit) 32, and the output unit 18.

The configuration except for the fourth operation unit 31 and the fourth Bootstrapping unit (the fourth calculation unit) 32 is the same as that illustrated in FIG. 2 and the description thereof is omitted.

The fourth operation unit 31 performs a fourth homomorphic operation for three binary input ciphertexts received by the receiving unit 11.

The fourth operation unit 31 is an operation processing unit that implements operations of an AOI gate and an OAI gate (homomorphic operations) by the logic gates (the AND circuit unit, the OR circuit unit, and the NOT circuit unit) described with reference to FIGS. 9 and 10 by software.

The fourth Bootstrapping unit 32 performs binary Gate Bootstrapping described below for the result of the operation by the fourth operation unit 31 and outputs a new ciphertext that can take two values as the output D1 or D2 of the AOI gate or the OAI gate.

FIG. 12 is a diagram for explaining operation processes of an AOI gate and an OAI gate based on the functional configuration in FIG. 11 in detail.

In the description of FIG. 12, the ciphertexts ca, cb, and cc input to the encryption processing apparatus 1 are all TLWE ciphertexts presented in the aforementioned paper.

TLWE encryption is Bit-wise type fully homomorphic encryption having 0 or μ (non-0) as the plaintext, although described in detail later.

Various operations can be performed by logical operations using logic gates.

A TLWE ciphertext has either of two values as its plaintext, the value being obtained by adding an error with a predetermined dispersion to a predetermined value corresponding to a binary symbol 0 or 1. The TLWE ciphertext can be subjected to a logical operation without being decrypted.

The configuration illustrated in FIG. 12 uses (binary) Gate Bootstrapping presented in Chillotti et al., 2020.

Gate Bootstrapping in TFHE presented in the aforementioned paper is described below in detail.

The input ciphertexts ca, cb, and cc are input to the fourth operation unit 31, a homomorphic operation is performed on them, and the result of that operation (the ciphertext ct=ciphertext ca×2+cb+cc) is input to the first Bootstrapping unit 15 that performs binary Gate Bootstrapping.

The output of the first Bootstrapping unit 15 is a ciphertext dc1 as the output D1 of the AOI gate or a ciphertext dc2 as the output D2 of the OAI gate which can take either of two values 0 and μ as the plaintext.

### Operation Process of AOI21 Gate

It is assumed that the TLWE ciphertexts ca, cb, and cc correspond to the inputs A, B, and C of the AOI21 gate, respectively.

These ciphertexts are TLWE ciphertexts based on system parameters specially set and are generated by Gate Bootstrapping or newly encrypted.

The TLWE ciphertexts ca, cb, and cc each have 0 or ⅙ as the plaintext, and the error added to the plaintext falls within a range of ± 1/48.

As for the TLWE ciphertexts ca, cb, and cc, 0 corresponds to a binary symbol 0, and ⅙ corresponds to a binary symbol 1.

First, the encryption processing apparatus 1 (the fourth operation unit 31) calculates 2×ca+cb+cc+(0, 1/12). (0, 1/12) is a trivial TLWE ciphertext having 1/12 as the plaintext.

The result of the operation 2×ca+cb+cc+(0, 1/12) is as follows.
When ca is 0, cb is 0, and cc is 0 (2×ca+cb+cc is 0+0+0=0 as a binary symbol)»2×0+0+0+ 1/12= 1/12.
When ca is 0, cb is 0, and cc is ⅙ (2×ca+cb+cc is 0+0+1=1 as a binary symbol)»2×0+0+⅙+ 1/12= 3/12.
When ca is 0, cb is ⅙, and cc is 0 (2×ca+cb+cc is 0+1+0=1 as a binary symbol)»2×0+1/6+0+ 1/12= 3/12.
When ca is 0, cb is ⅙, and cc is ⅙ (2×ca+cb+cc is 0+1+1=2 as a binary symbol)»2×0+⅙+⅙+ 1/12= 5/12.
When ca is ⅙, cb is 0, and cc is 0 (2×ca+cb+cc is 2+0+0=2 as a binary symbol)»2×⅙+0+0+ 1/12= 5/12.
When ca is ⅙, cb is 0, and cc is ⅙ (2×ca+cb+cc is 2+0+1=3 as a binary symbol)»2×⅙+0+⅙+ 1/12= 7/12.
When ca is ⅙, cb is ⅙, and cc is 0 (2×ca+cb+cc is 2+1+0=3 as a binary symbol)»2×⅙+⅙+0+ 1/12= 7/12.
When ca is ⅙, cb is ⅙, and cc is ⅙ (2×ca+cb+cc is 2+1+1=4 as a binary symbol)»2×⅙+⅙+⅙+ 1/12= 9/12.

The TLWE ciphertext ct is obtained which has any of five values of 1/12, 3/12, 5/12, 7/12, and 9/12 as the plaintext and in which the error added to the plaintext falls within a range of ± 1/16.

The encryption processing apparatus 1 (the fourth Bootstrapping unit 32) performs Gate Bootstrapping as described in the aforementioned paper for the TLWE ciphertext ct.

However, in Gate Bootstrapping, the encryption processing apparatus 1 performs BlindRotate using the following polynomial as a test vector.

Tx=μ1X⁽ⁿ⁻¹⁾+μ1X⁽ⁿ⁻²⁾+ . . . +μ1X^{(2/3n)}+μ2X^{(2/3n-1)}+ . . . μ2

where μ1=− 1/12 and μ2= 1/12.

The TLWE ciphertext obtained in the stage immediately after SampleExtract has 1/12 or − 1/12 as the plaintext from the following result.
When ca is 0, cb is 0, and cc is 0» 1/12.
When ca is 0, cb is 0, and cc is ⅙» 1/12.
When ca is 0, cb is ⅙, and cc is 0» 1/12.
When ca is 0, cb is ⅙, and cc is ⅙»− 1/12.
When ca is ⅙, cb is 0, and cc is 0»− 1/12.
When ca is ⅙, cb is 0, and cc is ⅙»− 1/12.
When ca is ⅙, cb is ⅙, and cc is 0»− 1/12.
When ca is ⅙, cb is ⅙, and cc is ⅙»− 1/12.

When (0, 1/12) is added to the above result and key switching is performed, the TLWE ciphertext cy having 0 or ⅙ as the plaintext is obtained in which 0 corresponds to a binary symbol 0, and ⅙ corresponds to a binary symbol 1.

The following table is a truth table indicating symbols that the TLWE ciphertext cy in accordance with input ciphertexts can take.

| ca | cb | cc | cy |
|---|---|---|---|
| 0 | 0 | 0 | 1 |
| 0 | 0 | 1 | 1 |
| 0 | 1 | 0 | 1 |
| 0 | 1 | 1 | 0 |
| 1 | 0 | 0 | 0 |
| 1 | 0 | 1 | 0 |
| 1 | 1 | 0 | 0 |
| 1 | 1 | 1 | 0 |

The result is the same as the operation result of the AOI21 gate described above, and it is found that the operation of the AOI21 gate has been performed correctly.

### Operation Process of OAI21 Gate

It is assumed that the TLWE ciphertexts ca, cb, and cc correspond to the inputs A, B, and C of the OAI21 gate, respectively.

These ciphertexts are TLWE ciphertexts based on system parameters specially set and are generated by Gate Bootstrapping or newly encrypted.

The TLWE ciphertexts ca, cb, and cc each have 0 or ⅙ as the plaintext, and the error added to the plaintext falls within a range of ± 1/48.

As for the TLWE ciphertexts ca, cb, and cc, 0 corresponds to a binary symbol 0, and ⅙ corresponds to a binary symbol 1.

First, the encryption processing apparatus 1 (the fourth operation unit 31) calculates 2×ca+cb+cc+(0, 1/12). (0, 1/12) is a trivial TLWE ciphertext having 1/12 as the plaintext.

The result of the operation 2×ca+cb+cc+(0, 1/12) is as follows.
When ca is 0, cb is 0, and cc is 0 (2×ca+cb+cc is 0+0+0=0 as a binary symbol)»2×0+0+0+ 1/12= 1/12.
When ca is 0, cb is 0, and cc is ⅙ (2×ca+cb+cc is 0+0+1=1 as a binary symbol)»2×0+0+⅙+ 1/12= 3/12.
When ca is 0, cb is ⅙, and cc is 0 (2×ca+cb+cc is 0+1+0=1 as a binary symbol)»2×0+⅙+0+ 1/12= 3/12.
When ca is 0, cb is ⅙, and cc is ⅙ (2×ca+cb+cc is 0+1+1=2 as a binary symbol)»2×0+⅙+⅙+ 1/12= 5/12.
When ca is ⅙, cb is 0, and cc is 0 (2×ca+cb+cc is 2+0+0=2 as a binary symbol)»2×⅙+0+0+ 1/12= 5/12.
When ca is ⅙, cb is 0, and cc is ⅙ (2×ca+cb+cc is 2+0+1=3 as a binary symbol)»2×⅙+0+⅙+ 1/12= 7/12.
When ca is ⅙, cb is ⅙, and cc is 0 (2×ca+cb+cc is 2+1+0=3 as a binary symbol)»2×⅙+⅙+0+ 1/12= 7/12.
When ca is ⅙, cb is ⅙, and cc is ⅙ (2×ca+cb+cc is 2+1+1=4 as a binary symbol)»2×⅙+⅙+⅙+ 1/12= 9/12.

The TLWE ciphertext ct is obtained which has any of five values of 1/12, 3/12, 5/12, 7/12, and 9/12 as the plaintext and in which the error added to the plaintext falls within a range of ± 1/16.

The encryption processing apparatus 1 (the fourth Bootstrapping unit 32) performs Gate Bootstrapping as described in the aforementioned paper for the TLWE ciphertext ct.

However, in Gate Bootstrapping, the encryption processing apparatus 1 performs BlindRotate using the following polynomial as a test vector.

Tx=μX⁽ⁿ⁻¹⁾+ . . . +μ

where μ= 1/12.

The TLWE ciphertext obtained in the stage immediately after SampleExtract has 1/12 or − 1/12 as the plaintext from the following result.
When ca is 0, cb is 0, and cc is 0» 1/12.
When ca is 0, cb is 0, and cc is ⅙» 1/12.
When ca is 0, cb is ⅙, and cc is 0» 1/12.
When ca is 0, cb is ⅙, and cc is ⅙» 1/12.
When ca is ⅙, cb is 0, and cc is 0» 1/12.
When ca is ⅙, cb is 0, and cc is ⅙»− 1/12.
When ca is ⅙, cb is ⅙, and cc is 0»− 1/12.
When ca is ⅙, cb is ⅙, and cc is ⅙»− 1/12.

When (0, 1/12) is added to the above result and key switching is performed, the TLWE ciphertext cy having 0 or ⅙ as the plaintext is obtained. 0 corresponds to a binary symbol 0, and ⅙ corresponds to a symbol 1.

The following table is a truth table indicating symbols that the TLWE ciphertext cy in accordance with input ciphertexts can take.

| ca | cb | cc | cy |
|---|---|---|---|
| 0 | 0 | 0 | 1 |
| 0 | 0 | 1 | 1 |
| 0 | 1 | 0 | 1 |
| 0 | 1 | 1 | 1 |
| 1 | 0 | 0 | 1 |
| 1 | 0 | 1 | 0 |
| 1 | 1 | 0 | 0 |
| 1 | 1 | 1 | 0 |

The result is the same as the operation result of the OAI21 gate described above, and it is found that the operation of the OAI21 gate has been performed correctly.

In a case of performing an operation of the AOI gate by using binary Gate Bootstrapping, as in the AOI gate illustrated in FIG. 9, Gate Bootstrapping has to be performed once in the latter stage in each of the AND circuit unit 61 and the OR circuit unit 62, i.e., twice in total.

In a case of performing an operation of the OAI gate by using binary Gate Bootstrapping as in the OAI gate illustrated in FIG. 10, Gate Bootstrapping has to be performed once in the latter stage in each of the OR circuit unit 71 and the AND circuit unit 72, i.e., twice in total.

Meanwhile, in the encryption processing apparatus 1 according to the present embodiment, in the operations of the AOI gate and the OAI gate, three binary ciphertexts are input to the fourth operation unit 31, and Gate Bootstrapping is improved. The number of times of the homomorphic operation process is thus reduced to one in total.

As a result, the encryption processing apparatus 1 can reduce the number of times of Gate Bootstrapping that occupies almost all the homomorphic operation process, to one in total. Therefore, as compared with the AOI gate illustrated in FIG. 9 and the OAI gate illustrated in FIG. 10, the encryption processing apparatus 1 can reduce a computation processing time by about 50%.

As described above, since Gate Bootstrapping occupies almost all the operation time of each of the AOI gate and the OAI gate related to fully homomorphic operation, the encryption processing apparatus 1 can significantly speed up operations of the AOI gate and the OAI gate by reducing the number of times of Gate Bootstrapping.

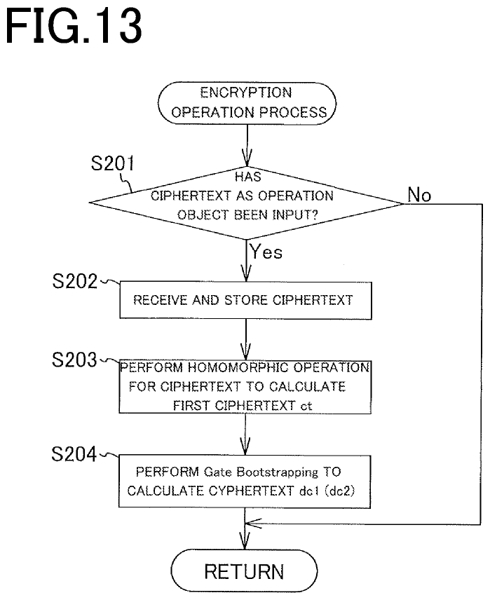

FIG. 13 is a flowchart for explaining a flow of operation processes of an AOI gate and an OAI gate performed by an encryption processing apparatus.

The encryption processing apparatus 1 (the receiving unit 11) determines whether ciphertexts as operation objects have been input at Step S301.

When it is determined that the ciphertexts have been input (Yes at Step S301), the encryption processing apparatus 1 (the receiving unit 11) receives the ciphertexts and stores them in the storage unit 20 at Step S302.

The encryption processing apparatus 1 (the fourth operation unit 31) then performs a homomorphic operation by using the ciphertexts and stores the operation result in the storage unit 20 at Step S303.

The encryption processing apparatus 1 (the fourth calculation unit 32) performs Gate Bootstrapping for the operation result, calculates the ciphertexts dc1 and dc2 as the outputs D1 and D2 of the AOI gate and the OAI gate, respectively, each having either of two values as the plaintext, and stores them in the storage unit 20 at Step S304.

In the processes by the fourth operation unit 31 and the fourth calculation unit 32, the following operation is performed.

This operation receives input of the three ciphertexts ca, cb, and cc each having either of two values as the plaintext, calculates the TLWE ciphertext ct from 2×ca+cb+cc+ 1/16, and performs Gate Bootstrapping on the calculation result, thereby obtaining the ciphertexts dc1 and dc2 as the outputs D1 and D2 of the AOI gate and the OAI gate.

For example, when each of the input three ciphertexts is a binary symbol 0 or 1, that is, in a section 0± 1/48 or ⅙± 1/48, and the fourth operation unit 31 performs the operation at Step S103, the following operation is performed.
When ca is 0, cb is 0, and cc is 0»2×0± 1/48+0± 1/48+0± 1/48+ 1/16= 1/16± 1/16.
When ca is 0, cb is 0, and cc is 1»2×0± 1/48+0± 1/48+⅛± 1/48+ 1/16= 3/16± 1/16.
When ca is 0, cb is 1, and cc is 0»2×0± 1/48+⅛± 1/48+0± 1/48+ 1/16= 3/16± 1/16.
When ca is 0, cb is 1, and cc is ¼»2×0± 1/48+⅛± 1/48+⅛± 1/48+ 1/16= 5/16± 1/16.
When ca is 1, cb is 0, and cc is 0»2×⅛± 1/48+0± 1/48+0± 1/48+ 1/16= 5/16± 1/16.
When ca is 1, cb is 0, and cc is 1»2×⅛± 1/48+0± 1/48+⅛± 1/48+ 1/16= 7/16± 1/16.
When ca is 1, cb is 1, and cc is 0»2×⅛± 1/48+⅛± 1/48+0± 1/48+ 1/16= 7/16± 1/16.
When ca is 1, cb is 1, and cc is 1»2×⅛± 1/48+⅛± 1/48+⅛± 1/48+ 1/16= 9/16± 1/16.

The ciphertext ct thus obtained has any of five values, i.e., 1/16, 3/16, 5/16, 7/16, and 9/16 as the plaintext, and the error added to the plaintext is included in a range of ± 1/16.

When the fourth calculation unit 32 performs Gate Bootstrapping as the process at Step S204, the ciphertext dc1 or dc2 is obtained which has 0 or ⅛ as the plaintext and in which the error added to the plaintext is included in a range of ± 1/48. These ciphertexts are set as the output D1 of the AOI gate and the output D2 of the OAI gate, respectively.

As described above, by making a range of error added to the plaintext of a TLWE ciphertext smaller, the number of times of a homomorphic operation can be reduced. Also, the number of times of Gate Bootstrapping after the homomorphic operation can be reduced to one.

In addition to speeding up a full adder mainly described in the present specification, the operations of the AOI gate and the OAI gate described above can be significantly sped up by applying to make the range of error added to the plaintext smaller thereto. Thus, simulation of a CMOS circuit using them can also be sped up.

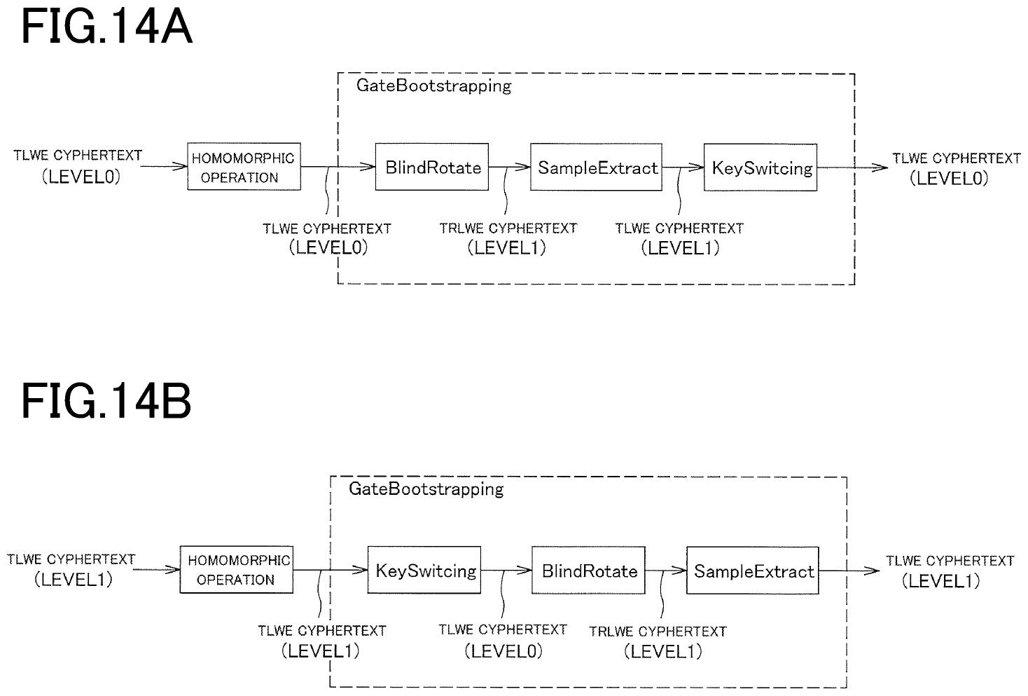

FIGS. 14A and 14B are diagrams illustrating ciphertexts input to and output from Gate Bootstrapping in the present embodiment.

In the above description, Gate Bootstrapping has been described as being performed in the order of BlindRotate, SampleExtract, and key switching as illustrated in FIG. 14A.

The order is not limited thereto. First, key switching can be performed in Gate Bootstrapping, as illustrated in FIG. 14B, and thereafter BlindRotate and SampleExtract can be performed.

There are concepts of levels for TLWE ciphertexts in accordance with the security strength.

In Gate Bootstrapping in FIG. 14A, TLWE ciphertexts as input and output are at LEVELO. BlindRotate is performed for the LEVELO TLWE ciphertext, and a TLWE ciphertext obtained by SampleExtract for a TRLWE ciphertext that is the output of BlindRotate becomes a LEVEL1 ciphertext. However, as a result of key switching, the LEVEL0 TLWE ciphertext is output.

Meanwhile, in the method illustrated in FIG. 14B, TLWE ciphertexts input to and output from Gate Bootstrapping are set at LEVEL1, and the level of the input ciphertext is lowered to LEVEL0 by key switching first. BlindRotate is then performed, and SampleExtract is performed for a TRLWE ciphertext that is the output of BlindRotate. Consequently, the LEVEL1 TLWE ciphertext is output.

The LEVEL0 ciphertext is formed by an N-th order vector [a] of elements on the circle group {T} encrypted with an N-th order private key [s]. Meanwhile, the LEVEL1 ciphertext obtained as a result of SampleExtract is formed by an n-th order vector [a′] of elements on the circle group {T} encrypted with an n-th order private key [s′].

Since the LEVEL0 ciphertext is less than the LEVEL1 ciphertext in the number of coefficients that determines the difficulty of the LWE problem (the number of the orders of the vector), the amount of computation of homomorphic addition is less than that at LEVEL1.

Meanwhile, the LEVEL0 ciphertext has a problem that its security strength tends to be lowered when an acceptable error added to the plaintext is made smaller in order to make a homomorphic operation using three binary inputs possible as in the aforementioned embodiments. This is because in LWE encryption, the safety is guaranteed by the error added to the plaintext.

As for TLWE encryption, as the error added the plaintext becomes larger and the number of the coefficients (the number of the orders of the vector) is larger, computation (decryption) is more difficult.

In other words, as for TLWE encryption, as the error added to the plaintext is smaller and the number of coefficients (the number of the orders of the vector) is smaller, computation (decryption) is easier.

In a case of making the error smaller, it is necessary to ensure the security by increasing the number of the coefficients in the ciphertext (the number of the orders of the vector).

In the examples, by making the error added to the plaintext smaller to, for example, ± 1/24, the number of times of BlindRotate is reduced by a homomorphic operation for three binary inputs, and an MUX operation is sped up. In order to ensure the security of the ciphertext that becomes easy to calculate (decrypt) because of reduction of the error added to the plaintext, it is desirable to move key switching to the top of Gate Bootstrapping and to use a LEVEL1 ciphertext, which has a large number of coefficients (the number of the orders of the vector) and for which the error range can be easily reduced, as the input and the output of Gate Bootstrapping. After the LEVEL1 ciphertext is converted to a LEVEL0 ciphertext at the top of Gate Bootstrapping, re-conversion to LEVEL0 is not performed last.

A time required for BlindRotate is in proportion to the number of coefficients in the TLWE ciphertext (the number of the orders of the vector) used as the input. Therefore, when a LEVEL1 ciphertext is used as the input, the time required for BlindRotate becomes longer in proportion to the number of coefficients (the number of the orders of the vector) than when a LEVEL0 ciphertext is input.

Even when a LEVEL1 ciphertext is used as the input of Gate Bootstrapping in order to ensure the security of ciphertext, increase in the required time can be avoided by performing BlindRotate by using a LEVEL0 TLWE ciphertext obtained by conversion by key switching as input.

The method of using LEVEL1 TLWE ciphertexts as the input and the output of Gate Bootstrapping can also be applied to a case of a homomorphic operation for two binary inputs, in addition to the case of performing a homomorphic operation for three binary inputs as in the examples. Since LEVEL1 is not converted to LEVEL0, input of multiple values can be performed with safety also in calculation of TLWE ciphertext in the next stage, so that high-speed processing can be achieved.

Further, reducing the error added to the plaintext to ± 1/24 or the like also has a problem of an error at the time of decoding, other than the security strength problem.

In the configuration of the present embodiment, the number of times of BlindRotate that occupies a large part of a processing time of Gate Bootstrapping can be made one. However, since the error range has to be set to be smaller, there are also problems of reduction of the security strength and increase in a decoding error rate.

In LWE homomorphic encryption including TFHE, the errors respectively added to plaintexts are distributed in a normal distribution, and “the error range” cannot be set strictly.

Although the errors concentrate around 0, it is only possible to make more errors concentrate in a specified range in principle.

For example, even when the error added to the plaintext is set within ± 1/24, the possibility that an error outside that range is added remains several percent.

If the error is out of the set range, the corresponding plaintext is interpreted as another plaintext, and it is therefore likely that an unexpected calculation result is obtained.

Calculation itself can be performed, but a different result is obtained. It depends on an application to which homomorphic encryption is applied how much probability that the different calculation result is obtained is acceptable.

In the present embodiment, by changing system parameters to set the error added to the plaintext to ± 1/24, three goals, i.e., suppressing the probability that an error occurs in calculation, speeding up calculation by reducing the number of times of BlindRotate, and maintaining the security to be high can be achieved in a well-balanced manner.

In order to achieve the best balance, it is necessary to set the system parameters to provide the error that makes overlapping of error ranges fall within a certain value.

The error may be set depending on a system or a apparatus to which the present embodiment is applied so as to satisfy a condition of particular importance.

In a case of putting importance on speeding up an operation, the error added to the plaintext is set within a range of ± 1/32. This setting also enables a homomorphic operation for four binary inputs, for example.

In an application that accepts the possibility that a different calculation result is obtained to some extent, calculation is sped up by using three binary inputs while the possibility of overlapping of the error ranges is accepted to some extent, and at the same time the security is maintained by setting the error range to a large range, e.g., within ± 1/16.

For example, even when the parameters in the aforementioned paper, which is set such that the error added to the plaintext is within ± 1/16, are used, the configuration of the present embodiment that speeds up a full adder by a homomorphic operation using three binary inputs is possible, in principle. What happens in this case is only increase in the probability that an error is out of the set range and a different calculation result is obtained.

### APPLICATION EXAMPLE

The speed increase of a full adder achieved by the encryption processing apparatus 1 can be applied as follows.

For example, there is considered a case in which it is desired to aggregate, from a database in which fields and/or records are encrypted by TLWE encryption, records each having a specific field within a certain range (for example, a case in which it is desired to obtain an average annual income of 30 to 39 years old).

In this case, the encryption processing apparatus 1 is a database sever that manages the encrypted database, receives a query encrypted by TLWE encryption from a terminal device connected thereto via a network or the like, and returns a response to the query which is encrypted by TLWE encryption to the terminal device.

Since an index cannot be created in the encrypted database, it is necessary to perform comparison and aggregation for the entire database.

The encryption processing apparatus 1 performs a comparison operation that compares all the records of the encrypted database with the query by functions of the first operation unit 12, the second operation unit 13, the third operation unit 14, the first Bootstrapping unit 15, the second Bootstrapping unit 16, and the third Bootstrapping unit 17 that implement a full adder.

The comparison operation is to perform subtraction between a ciphertext of a record and a ciphertext of a query, and the sign of the subtraction result is equivalent to the comparison operation.

The encryption processing apparatus 1 can further perform an aggregate operation for records that match the query in the comparison operation.

In the aggregate operation, the encryption processing apparatus 1 adds the records that match the query in the comparison operation to calculate a total, and further obtains an average value by using division.

As described above, in processing of a query with respect to an encrypted database, it is necessary to perform four arithmetic operations such as addition, subtraction, multiplication, and division, and comparison (comparison is equivalent to positive or negative of a subtraction result) between integers constituting ciphertexts. In addition, it is considered that a full adder operation is frequently used for the processing. If the bit length of an integer to be handled becomes large, the number of required full adders also increases.

With speed increase of an operation by the full adder by reduction of the number of times of the above-described logical operation and reduction of the number of times of Gate Bootstrapping, the time for query execution can be significantly reduced.

The four arithmetic operations are homomorphic four arithmetic operations with respect to encrypted numerical values that are regarded as ciphertexts of respective bits when a permutation using an input ciphertext is expressed in binary.

The four arithmetic operations and comparison between integers are used not only for aggregation in the database described above, but also in various data processing using ciphertexts frequently.

Other examples include fuzzy authentication and fuzzy search.

Fuzzy authentication is biometric authentication using, for example, biometric authentication data, and it is an absolute condition that biometric authentication data that does not change over a lifetime is encrypted and concealed.

In fuzzy authentication, authentication is performed based on a correspondence between biometric authentication data presented as an authentication request and biometric authentication data registered in a database. It is determined whether both the data match each other with a threshold, instead of determining whether both the data completely match each other.

Fuzzy search is an ambiguous search method in which data close to a query is presented as a search result from a database even if the query and a record do not completely match.

In fuzzy authentication and fuzzy search, the encrypted database and the query are compared with each other, as in the comparison operation and the aggregate operation in the encrypted database described above. At this time, it is necessary to perform the comparison operation using the data encrypted by homomorphic encryption.

In particular, in fuzzy authentication and fuzzy search, addition, subtraction, multiplication, division, and comparison between integers occupy most of the processing time, and therefore a significant effect can be obtained in shortening the processing time by speeding up an operation by a full adder used for these operations.

In addition, the Euclidean distance is often used for comparison in fuzzy authentication and fuzzy search. When the Euclidean distance is calculated, calculation of a square is required. Therefore, in Bit-wise type homomorphic encryption, O (N²) full adders must be caused to operate with respect to the bit length of data when multiplication is performed. Even in a comparison operation by simple subtraction, it is necessary to operate O (N) full adders. Therefore, by speeding up an operation by a full adder, the processing time required for fuzzy authentication or fuzzy search can be largely reduced.

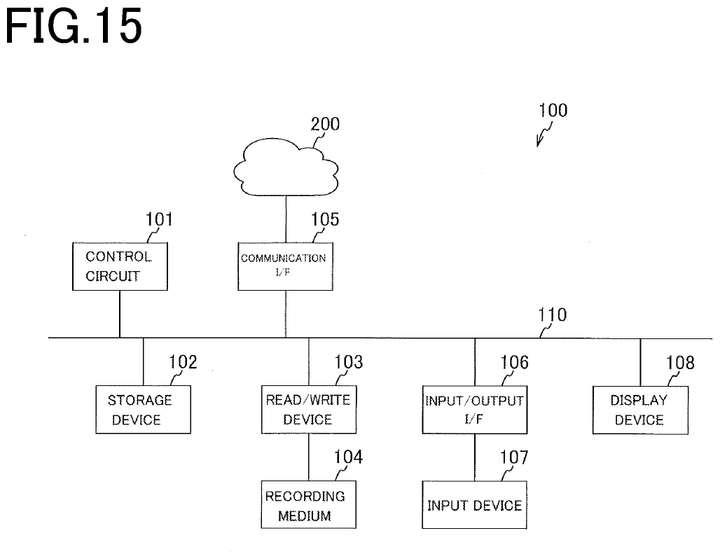

FIG. 15 is a block diagram illustrating an example of a computer apparatus.

The configuration of a computer apparatus 100 is described with reference to FIG. 15.

The computer apparatus 100 is, for example, an encryption processing apparatus that processes various types of information. The computer apparatus 100 includes a control circuit 101, a storage device 102, a read/write device 103, a recording medium 104, a communication interface 105, an input/output interface 106, an input device 107, and a display device 108. The communication interface 105 is connected to a network 200. The respective constituent elements are mutually connected to one another via a bus 110.

The encryption processing apparatus 1 can be configured by a part or all elements which are selected from the constituent elements described in the computer apparatus 100 as appropriate.

The control circuit 101 controls the entire computer device 100. For example, the control circuit 101 is a processor such as a Central Processing Unit (CPU), a Field Programmable Gate Array (FPGA), an Application Specific Integrated Circuit (ASIC), and a Programmable Logic Device (PLD). The control circuit 101 functions as the controller 10 in FIGS. 2 and 11, for example.

The storage device 102 stores various types of data therein. For example, the storage device 102 is a non-transitory computer-readable recording medium such as a memory such as a Read Only Memory (ROM) and a Random Access Memory (RAM), a Hard Disk (HDD), and a Solid State Drive (SSD). The storage device 102 may store therein an information processing program (encryption processing program) that causes the control circuit 101 to function as the controller 10 in FIG. 2. The storage device 102 functions as the storage unit 20 in FIGS. 2 and 11, for example.

The encryption processing apparatus 1 loads an encryption processing program stored in the storage device 102 into a RAM when performing information processing.

The encryption processing apparatus 1 executes the encryption processing program loaded to the RAM by the control circuit 101, thereby performing processing that includes at least one of a receiving process, a first operation process, a second operation process, a third operation process, a fourth operation process, a first Bootstrapping process, a second Bootstrapping process, a third Bootstrapping process, a fourth Bootstrapping process, and an output process.

The information processing program may be stored in a storage device included in a server on the network 200, as long as the control circuit 101 can access that program via the communication interface 105.

The read/write device 103 is controlled by the control circuit 101, and reads data in the removable recording medium 104 and writes data to the removable recording medium 104.

The recording medium 104 stores various types of data therein. The recording medium 104 stores information processing program (an encryption processing program) therein, for example. For example, the recording medium 104 is a non-volatile memory (non-transitory computer-readable recording medium) such as a Secure Digital (SD) memory card, a Floppy Disk (FD), a Compact Disc (CD), a Digital Versatile Disk (DVD), a Blu-ray (registered trademark) Disk (BD), and a flash memory.

The communication interface 105 connects the computer apparatus 100 and another device to each other via the network 200 in a communicable manner. The communication interface 105 functions as the communication unit 25 in FIG. 2, for example.

The input/output interface 106 is, for example, an interface that can be connected to various types of input devices in a removable manner. Examples of the input device 107 connected to the input/output interface 106 include a keyboard and a mouse. The input/output interface 106 connects each of the various types of input devices connected thereto and the computer apparatus 100 to each other in a communicable manner. The input/output interface 106 outputs a signal input from each of the various types of input devices connected thereto to the control circuit 101 via the bus 110. The input/output interface 106 also outputs a signal output from the control circuit 101 to an input/output device via the bus 110. The input/output interface 106 functions as the input unit 26 in FIG. 2, for example.

The display device 108 displays various types of information. The network 200 is, for example, a LAN, wireless communication, a P2P network, or the Internet and communicably connects the computer apparatus 100 to other devices.

The present embodiment is not limited to the embodiment described above and various configurations or embodiments can be applied within a scope not departing from the gist of the present embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

Further, the following notes are disclosed regarding the embodiments including the Examples described above. The present invention is not limited by the following notes.

(Note 1) An encryption processing apparatus that processes a ciphertext that is a fully homomorphic cyphertext having as a plaintext either one of two values, the value being obtained by adding an error with a predetermined variance to a predetermined value corresponding to a symbol 0 or 1, and being able to be subjected to a logical operation without being decrypted,
the apparatus including: an operation unit performing a homomorphic operation related to a predetermined operation for two or more of the ciphertexts for which an error range is set to make a range of an error added to a plaintext after the homomorphic operation fall within a predetermined value; and a calculation unit calculating a new ciphertext by applying a predetermined polynomial to a ciphertext that is a result of the homomorphic operation, wherein
the calculation unit factorizes each of a plurality of the polynomials into a common polynomial common to the polynomials and an uncommon polynomial not common to the polynomials, and
calculates a plurality of the new ciphertexts by using a plurality of ciphertexts calculated by applying the common polynomial to the result of homomorphic operation, and the uncommon polynomial.
   (Note 2) An encryption processing apparatus that processes a ciphertext that is a fully homomorphic cyphertext having as a plaintext either one of two values, the value being obtained by adding an error with a predetermined variance to a predetermined value corresponding to a symbol 0 or 1, and being able to be subjected to a logical operation without being decrypted,
the apparatus including: an operation unit performing a homomorphic operation related to a predetermined operation for two or more of the ciphertexts for which an error range is set to make a range of an error added to a plaintext after the homomorphic operation fall within a predetermined value; and a calculation unit calculating a new ciphertext by applying a predetermined polynomial to a ciphertext that is a result of the homomorphic operation, wherein
the ciphertext has a plurality of values as elements of the ciphertext,
the calculation unit includes a first calculation unit performing calculation of making the plurality of values integers, the integers being all the same in a remainder when being divided by a predetermined value, and a second calculation unit reducing an error of the new ciphertext by using the polynomial, the polynomial having a plurality of coefficients that are the same for every predetermined value, and
the calculation unit calculates the new ciphertext by using each of the coefficients.
   (Note 3) The encryption processing apparatus according to Note 1 or 2, wherein the number of coefficients in a ciphertext is reduced, prior to calculating the new ciphertext by applying the predetermined polynomial to the result of the homomorphic operation.
   (Note 4) The encryption processing apparatus according to any one of Notes 1 to 3, wherein the predetermined operation is a full adder operation.
   (Note 5) The encryption processing apparatus according to Note 4, wherein the full adder operation is performed as the predetermined operation to perform homomorphic four arithmetic operations between encrypted numerical values respectively regarded as ciphertexts of bits when a permutation using the ciphertext input is expressed in binary.
   (Note 6) The encryption processing apparatus according to Note 4, wherein the full adder operation is performed as the predetermined operation to perform fuzzy authentication or fuzzy search using the input ciphertext.
   (Note 7) The encryption processing apparatus according to Note 4, wherein the full adder operation is performed as the predetermined operation to process a query based on the input ciphertext to an encrypted database.
   (Note 8) The encryption processing apparatus according to Note 1 or 2, wherein the predetermined operation is equivalent to an operation of an AOI21 gate or an OAI21 gate.
   (Note 9) An encryption processing method executed by a processor which processes a ciphertext that is a fully homomorphic cyphertext having as a plaintext either one of two values, the value being obtained by adding an error with a predetermined variance to a predetermined value corresponding to a symbol 0 or 1, and being able to be subjected to a logical operation without being decrypted,
the method including: performing a homomorphic operation related to a predetermined operation for two or more of the ciphertexts for which an error range is set to make a range of an error added to a plaintext after the homomorphic operation fall within a predetermined value; and calculating a new ciphertext by applying a predetermined polynomial to a ciphertext that is a result of the homomorphic operation, wherein
as calculation of the new ciphertext, a plurality of the polynomials are each factorized into a common polynomial common to the polynomials and an uncommon polynomial not common to the polynomials, and
a plurality of the new ciphertexts are calculated by using a plurality of ciphertexts calculated by applying the common polynomial to the result of homomorphic operation, and the uncommon polynomial.
   (Note 10) An encryption processing program causing a processor to execute an encryption processing method of processing a ciphertext,
the ciphertext being a fully homomorphic cyphertext that has as a plaintext either one of two values, the value being obtained by adding an error with a predetermined variance to a predetermined value corresponding to a symbol 0 or 1, and is able to be subjected to a logical operation without being decrypted,
the method including: performing a homomorphic operation related to a predetermined operation for two or more of the ciphertexts for which an error range is set to make a range of an error added to a plaintext after the homomorphic operation fall within a predetermined value; and calculating a new ciphertext by applying a predetermined polynomial to a ciphertext that is a result of the homomorphic operation, wherein
as calculation of the new ciphertext, a plurality of the polynomials are each factorized into a common polynomial common to the polynomials and an uncommon polynomial not common to the polynomials, and
a plurality of the new ciphertexts are calculated by using a plurality of ciphertexts calculated by applying the common polynomial to the result of homomorphic operation, and the uncommon polynomial.
   (Note 11) An encryption processing method, executed by a processor, which processes a ciphertext,
the ciphertext being a fully homomorphic cyphertext that has as a plaintext either one of two values, the value being obtained by adding an error with a predetermined variance to a predetermined value corresponding to a symbol 0 or 1, and is able to be subjected to a logical operation without being decrypted,
the method including: performing a homomorphic operation related to a predetermined operation for two or more of the ciphertexts for which an error range is set to make a range of an error added to a plaintext after the homomorphic operation fall within a predetermined value; and calculating a new ciphertext by applying a predetermined polynomial to a ciphertext that is a result of the homomorphic operation, wherein
the ciphertext has a plurality of values as elements of the ciphertext,
in calculation of the new ciphertext, a first calculation process of performing calculation of making the plurality of values integers and a second calculation process of reducing an error of the new ciphertext by using the polynomial are performed,
the integers calculated in the first calculation process are all the same in a remainder when being divided by a predetermined value,
the polynomial has a plurality of coefficients that are the same for every predetermined value, and
the new ciphertext is calculated by using each of the coefficients.
   (Note 12) An encryption processing program causing a processor to execute an encryption processing method of processing a ciphertext,
the ciphertext being a fully homomorphic cyphertext that has as a plaintext either one of two values, the value being obtained by adding an error with a predetermined variance to a predetermined value corresponding to a symbol 0 or 1, and is able to be subjected to a logical operation without being decrypted,
the program including: performing a homomorphic operation related to a predetermined operation for two or more of the ciphertexts for which an error range is set to make a range of an error added to a plaintext after the homomorphic operation fall within a predetermined value; and calculating a new ciphertext by applying a predetermined polynomial to a ciphertext that is a result of the homomorphic operation, wherein
the ciphertext has a plurality of values as elements of the ciphertext,
in calculation of the new ciphertext, a first calculation process of performing calculation of making the plurality of values integers and a second calculation process of reducing an error of the new ciphertext by using the polynomial are performed,
the integers calculated in the first calculation process are all the same in a remainder when being divided by a predetermined value,
the polynomial has a plurality of coefficients that are the same for every predetermined value, and
the new ciphertext is calculated by using each of the coefficients.
   (Note 13) An encryption processing apparatus that processes a ciphertext,
the ciphertext being a fully homomorphic cyphertext that has as a plaintext either one of two values, the value being obtained by adding an error with a predetermined variance to a value corresponding to a symbol 0 or 1 in a division region obtained by dividing a value region into a predetermined number, and that is able to be subjected to a logical operation without being decrypted,
the apparatus including: an operation unit performing a homomorphic operation related to a predetermined operation for three or more of the ciphertexts; and a calculation unit calculating a new ciphertext by applying a first polynomial to a ciphertext that is a result of the homomorphic operation, wherein
an error range for the three or more ciphertexts is set to make an error added to a plaintext of the ciphertext that is the result of the homomorphic operation fall within a range of a divided region obtained by dividing a value region of the plaintext of the ciphertext that is the result of the homomorphic operation.
   (Note 14) The encryption processing apparatus according to Note 13 is an encryption processing apparatus performing an operation of fully homomorphic encryption that processes a value on a cyclic group cycling from 0 to a predetermined value, while the value is encrypted, wherein
the three or more ciphertexts are a first ciphertext corresponding to a plaintext obtained by adding an error to 0 or ¼ of the predetermined value, a second ciphertext corresponding to a plaintext obtained by adding an error to 0 or ¼ of the predetermined value, and a third ciphertext corresponding to a plaintext obtained by adding an error to 0 or ¼ of the predetermined value,
the operation unit adds the first ciphertext, the second ciphertext, and the third ciphertext together while these ciphertexts are encrypted and subtracts a fourth ciphertext of ⅛ of the predetermined value while the fourth ciphertext is encrypted, to obtain a fifth ciphertext,
the calculation unit obtains a sixth ciphertext of a second polynomial obtained by making coefficients of the first polynomial cycle in accordance with the fifth ciphertext, and extracts a seventh ciphertext of coefficients of the second polynomial from the sixth ciphertext, which provides a plaintext corresponding to the fifth ciphertext,
the operation unit adds the fifth ciphertext, the fifth ciphertext and an eighth ciphertext of ¼ of the predetermined value together while these ciphertexts are encrypted, to obtain a ninth ciphertext, and
the calculation unit obtains a tenth ciphertext of a third polynomial obtained by making the coefficients of the first polynomial cycle in accordance with the ninth ciphertext and extracts an eleventh ciphertext of coefficients of the third polynomial from the tenth ciphertext, which provides a plaintext corresponding to the ninth ciphertext.
   (Note 15) The encryption processing apparatus according to Note 14, wherein
the seventh ciphertext is a ciphertext corresponding to a carry out,
the eleventh ciphertext is a ciphertext corresponding to a sum output, and
the calculation unit
extracts the seventh ciphertext corresponding to a plaintext obtained by adding an error to 0 when the plaintext of the fifth ciphertext is from 0 to ¼ of the predetermined value or ¾ of the predetermined value to the predetermined value, and extracts the seventh ciphertext corresponding to a plaintext obtained by adding an error to ¼ of the predetermined value when the plaintext of the fifth ciphertext is from ¼ of the predetermined value to ¾ of the predetermined value, and
extracts the eleventh ciphertext corresponding to a plaintext obtained by adding an error to 0 when the plaintext of the ninth ciphertext is from 0 to ¼ of the predetermined value or ¾ of the predetermined value to the predetermined value, and extracts the eleventh ciphertext corresponding to a plaintext obtained by adding an error to ½ of the predetermined value when the plaintext of the ninth ciphertext is from ¼ of the predetermined value to ¾ of the predetermined value.
   (Note 16) The encryption processing apparatus according to Note 14 or 15, wherein the error is less than 1/24 of the predetermined value.
   (Note 17) The encryption processing apparatus according to Note 14 or 15, wherein the error is acceptable in an application to which the encryption processing apparatus is applied and is 1/24 or more of the predetermined value, depending on a probability that a different calculation result is obtained.
   (Note 18) The encryption processing apparatus according to Note 13, the apparatus performing an operation of fully homomorphic encryption that processes a value on a cyclic group cycling from 0 to a predetermined value, while the value is encrypted, wherein
the three or more ciphertexts are a first ciphertext corresponding to a plaintext obtained by adding an error to 0 or ⅛ of the predetermined value, a second ciphertext corresponding to a plaintext obtained by adding an error to 0 or ⅛ of the predetermined value, and a third ciphertext corresponding to a plaintext obtained by adding an error to 0 or ⅛ of the predetermined value,
the operation unit adds the first ciphertext, the second ciphertext, and the third ciphertext together while these ciphertexts are encrypted and adds a fourth ciphertext of 1/16 of the predetermined value while the fourth ciphertext is encrypted, to obtain a fifth ciphertext,
the calculation unit obtains a sixth ciphertext of a second polynomial obtained by making coefficients of the first polynomial cycle in accordance with the fifth ciphertext, and extracts a seventh ciphertext of coefficients of the second polynomial from the sixth ciphertext, which provides a plaintext as a carry out corresponding to the fifth ciphertext, and
the calculation unit obtains an eighth ciphertext of a fourth polynomial obtained by making the coefficients of the third polynomial cycle in accordance with the fifth ciphertext and extracts a ninth ciphertext of coefficients of the fourth polynomial from the eighth ciphertext, which provides a plaintext as a sum output corresponding to the fifth ciphertext.
   (Note 19) The encryption processing apparatus according to Note 18, wherein the error is less than 1/48 of the predetermined value.
   (Note 20) The encryption processing apparatus according to Note 18 or 19, wherein the error is acceptable in an application to which the encryption processing apparatus is applied and is 1/48 or more of the predetermined value, depending on a probability that a different calculation result is obtained.
   (Note 21) An encryption processing apparatus that processes a ciphertext,
the ciphertext being a fully homomorphic cyphertext that has as a plaintext either one of two values, the value being obtained by adding an error with a predetermined variance to a predetermined value corresponding to a symbol 0 or 1 in a division region obtained by dividing a value region into a predetermined number, and that is able to be subjected to a logical operation without being decrypted,
the apparatus including: an operation unit performing a homomorphic operation related to a predetermined operation for two of the ciphertexts; and a calculation unit calculating a new ciphertext by applying a first polynomial to a ciphertext that is a result of the homomorphic operation, wherein
an error range for the two ciphertexts is set to make an error added to a plaintext of the ciphertext that is the result of the homomorphic operation fall within a range of a divided region obtained by dividing a value region of the plaintext of the ciphertext that is the result of the homomorphic operation.
   (Note 22) An encryption processing method, executed by a processor, which processes a ciphertext,
the ciphertext being a fully homomorphic cyphertext that has as a plaintext either one of two values, the value being obtained by adding an error with a predetermined variance to a value corresponding to a symbol 0 or 1 in a division region obtained by dividing a value region into a predetermined number, and that is able to be subjected to a logical operation without being decrypted,
the method including: performing a homomorphic operation related to a predetermined operation for three or more of the ciphertexts; and calculating a new ciphertext by applying a first polynomial to a ciphertext that is a result of the homomorphic operation, wherein
an error range for the three or more ciphertexts is set to make an error added to a plaintext of the ciphertext that is the result of the homomorphic operation fall within a range of a divided region obtained by dividing a value region of the plaintext of the ciphertext that is the result of the homomorphic operation.
   (Note 23) An encryption processing program causing a processor to execute an encryption processing method of processing a ciphertext,
the ciphertext being a fully homomorphic cyphertext that has as a plaintext either one of two values, the value being obtained by adding an error with a predetermined variance to a value corresponding to a symbol 0 or 1 in a division region obtained by dividing a value region into a predetermined number, and that is able to be subjected to a logical operation without being decrypted,
the program including: performing a homomorphic operation related to a predetermined operation for three or more of the ciphertexts; and calculating a new ciphertext by applying a first polynomial to a ciphertext that is a result of the homomorphic operation, wherein
an error range for the three or more ciphertexts is set to make an error added to a plaintext of the ciphertext that is the result of the homomorphic operation fall within a range of a divided region obtained by dividing a value region of the plaintext of the ciphertext that is the result of the homomorphic operation.

1. An encryption processing apparatus that processes a ciphertext,
the ciphertext being a fully homomorphic cyphertext that has as a plaintext either one of two values, the value being obtained by adding an error with a predetermined variance to a predetermined value corresponding to a symbol 0 or 1, and that is able to be subjected to a logical operation without being decrypted,
the apparatus comprising a processor that executes a process including:
performing a homomorphic operation related to a predetermined operation for three or more of the ciphertexts for which an error range is set to make a range of an error added to a plaintext after the homomorphic operation fall within a predetermined value; and
calculating a new ciphertext by applying a predetermined polynomial to a ciphertext that is a result of the homomorphic operation, wherein
the calculation includes
factorizing each of a plurality of the polynomials into a common polynomial common to the polynomials and an uncommon polynomial not common to the polynomials, and
calculating a plurality of the new ciphertexts by using a plurality of ciphertexts calculated by applying the common polynomial to the result of homomorphic operation, and using the uncommon polynomial.

2. The encryption processing apparatus according to claim 1, wherein the process executed by the processor further includes
reducing the number of coefficients in a ciphertext, prior to calculating the new ciphertext by applying the predetermined polynomial to the result of the homomorphic operation.

3. The encryption processing apparatus according to claim 1, wherein the predetermined operation is an operation by a full adder.

4. The encryption processing apparatus according to claim 3, wherein the process executed by the processor further includes
performing the operation by full adder as the predetermined operation to perform homomorphic four arithmetic operations between encrypted numerical values respectively regarded as ciphertexts of bits when a permutation using an input of the ciphertext is expressed in binary.

5. The encryption processing apparatus according to claim 1, wherein the predetermined operation is equivalent to an operation of an AOI21 gate or an OAI21 gate.

6. A non-transitory computer-readable recording medium storing an encryption processing program for causing a processor to execute an encryption process of processing a ciphertext,
the ciphertext being a fully homomorphic cyphertext that has as a plaintext either one of two values, the value being obtained by adding an error with a predetermined variance to a predetermined value corresponding to a symbol 0 or 1, and that is able to be subjected to a logical operation without being decrypted,
the encryption process including:
performing a homomorphic operation for three or more of the ciphertexts for which an error range is set to make a range of an error added to a plaintext after the homomorphic operation fall within a predetermined value; and
calculating a new ciphertext by applying a predetermined polynomial to a ciphertext that is a result of the homomorphic operation, wherein
the calculation includes
factorizing each of a plurality of the polynomials into a common polynomial common to the polynomials and an uncommon polynomial not common to the polynomials, and
calculating a plurality of the new ciphertexts by using a plurality of ciphertexts calculated by applying the common polynomial to the result of homomorphic operation, and using the uncommon polynomial.

7. An encryption processing apparatus that processes a ciphertext,
the ciphertext being a fully homomorphic cyphertext that has as a plaintext either one of two values, the value being obtained by adding an error with a predetermined variance to a predetermined value corresponding to a symbol 0 or 1, and that is able to be subjected to a logical operation without being decrypted,
the apparatus comprising a processor executing a process including:
performing a homomorphic operation related to a predetermined operation for three or more of the ciphertexts for which an error range is set to make a range of an error added to a plaintext after the homomorphic operation fall within a predetermined value; and
calculating a new ciphertext by applying a predetermined polynomial to a ciphertext that is a result of the homomorphic operation, wherein
the ciphertext has a plurality of values as elements of the ciphertext,
the calculation includes
performing calculation of making the plurality of values integers, the integers being all the same in a remainder when being divided by a predetermined value, and
reducing an error of the new ciphertext by using the polynomial, the polynomial having a plurality of coefficients that are the same for every predetermined value, and
the calculation calculates the new ciphertext by using each of the coefficients.

8. The encryption processing apparatus according to claim 7, wherein the process executed by the processor further includes reducing the number of coefficients in a ciphertext, prior to calculating the new ciphertext by applying the predetermined polynomial to the result of the homomorphic operation.

9. The encryption processing apparatus according to claim 7, wherein the predetermined operation is an operation by a full adder.

10. The encryption processing apparatus according to claim 7, wherein the predetermined operation is equivalent to an operation of an AOI21 gate or an OAI21 gate.

11. A non-transitory computer-readable recording medium storing an encryption processing program for causing a processor to execute an encryption process of processing a ciphertext,
the ciphertext being a fully homomorphic cyphertext that has as a plaintext either one of two values,
the value being obtained by adding an error with a predetermined variance to a predetermined value corresponding to a symbol 0 or 1, and that is able to be subjected to a logical operation without being decrypted,
the encryption process including:
performing a homomorphic operation for three or more of the ciphertexts for which an error range is set to make a range of an error added to a plaintext after the homomorphic operation fall within a predetermined value; and
calculating a new ciphertext by applying a predetermined polynomial to a ciphertext that is a result of the homomorphic operation, wherein
the ciphertext has a plurality of values as elements of the ciphertext,
the calculation includes
performing calculation of making the plurality of values integers, the integers being all the same in a remainder when being divided by a predetermined value, and
reducing an error of the new ciphertext by using the polynomial, the polynomial having a plurality of coefficients that are the same for every predetermined value, and the calculation calculates the new ciphertext by using each of the coefficients.

12. An encryption processing apparatus that processes a ciphertext,
the ciphertext being a fully homomorphic cyphertext that has as a plaintext either one of two values, the value being obtained by adding an error with a predetermined variance to a value corresponding to a symbol 0 or 1 in a division region obtained by dividing a value region into a predetermined number, and that is able to be subjected to a logical operation without being decrypted,
the apparatus comprising a processor that executes a process including:
performing a homomorphic operation related to a predetermined operation for three or more of the ciphertexts; and
calculating a new ciphertext by applying a first polynomial to a ciphertext that is a result of the homomorphic operation, wherein
an error range for the three or more of the ciphertexts is set to make an error added to a plaintext of the ciphertext that is the result of the homomorphic operation fall within a range of a divided region obtained by dividing a value region of the plaintext of the ciphertext that is the result of the homomorphic operation.

13. The encryption processing apparatus according to claim 12, wherein
the apparatus is an encryption processing apparatus performing an operation of fully homomorphic encryption that processes a value on a cyclic group cycling from 0 to a predetermined value, while the value is encrypted,
the three or more of the ciphertexts are a first ciphertext corresponding to a plaintext obtained by adding an error to 0 or ¼ of the predetermined value, a second ciphertext corresponding to a plaintext obtained by adding an error to 0 or ¼ of the predetermined value, and a third ciphertext corresponding to a plaintext obtained by adding an error to 0 or ¼ of the predetermined value, and
the process executed by the processor includes
adding the first ciphertext, the second ciphertext, and the third ciphertext together while these ciphertexts are encrypted and subtracting a fourth ciphertext of ⅛ of the predetermined value while the fourth ciphertext is encrypted, to obtain a fifth ciphertext,
obtaining a sixth ciphertext of a second polynomial obtained by making coefficients of the first polynomial cycle in accordance with the fifth ciphertext,
extracting a seventh ciphertext of coefficients of the second polynomial from the sixth ciphertext, which provides a plaintext corresponding to the fifth ciphertext,
adding the fifth ciphertext and an eighth ciphertext of ¼ of the predetermined value together while these ciphertexts are encrypted, to obtain a ninth ciphertext, and
obtaining a tenth ciphertext of a third polynomial obtained by making the coefficients of the first polynomial cycle in accordance with the ninth ciphertext, and extracting an eleventh ciphertext of coefficients of the third polynomial from the tenth ciphertext, which provides a plaintext corresponding to the ninth ciphertext.

14. The encryption processing apparatus according to claim 13, wherein
the seventh ciphertext is a ciphertext corresponding to a carry out, and
the eleventh ciphertext is a ciphertext corresponding to a sum output,
the process executed by the processor includes
extracting the seventh ciphertext corresponding to a plaintext obtained by adding an error to 0 when the plaintext of the fifth ciphertext is from 0 to ¼ of the predetermined value or ¾ of the predetermined value to the predetermined value, and extracting the seventh ciphertext corresponding to a plaintext obtained by adding an error to ¼ of the predetermined value when the plaintext of the fifth ciphertext is from ¼ of the predetermined value to ¾ of the predetermined value, and
extracting the eleventh ciphertext corresponding to a plaintext obtained by adding an error to 0 when the plaintext of the ninth ciphertext is from 0 to ¼ of the predetermined value or ¾ of the predetermined value to the predetermined value, and extracting the eleventh ciphertext corresponding to a plaintext obtained by adding an error to ½ of the predetermined value when the plaintext of the ninth ciphertext is from ¼ of the predetermined value to ¾ of the predetermined value.

15. The encryption processing apparatus according to claim 13, wherein the error is less than 1/24 of the predetermined value.

16. The encryption processing apparatus according to claim 13, wherein the error is acceptable in an application to which the encryption processing apparatus is applied and is 1/24 or more of the predetermined value, depending on a probability that a different calculation result is obtained.

17. The encryption processing apparatus according to claim 12, wherein
the apparatus is an encryption processing apparatus performing an operation of fully homomorphic encryption that processes a value on a cyclic group cycling from 0 to a predetermined value while the value is encrypted,
the three or more of the ciphertexts are a first ciphertext corresponding to a plaintext obtained by adding an error to 0 or ⅛ of the predetermined value, a second ciphertext corresponding to a plaintext obtained by adding an error to 0 or ⅛ of the predetermined value, and a third ciphertext corresponding to a plaintext obtained by adding an error to 0 or ⅛ of the predetermined value, and
the process executed by the processor includes
adding the first ciphertext, the second ciphertext, and the third ciphertext together while these ciphertexts are encrypted, and adding a fourth ciphertext of 1/16 of the predetermined value while the fourth ciphertext is encrypted, to obtain a fifth ciphertext,
obtaining a sixth ciphertext of a second polynomial obtained by making coefficients of the first polynomial cycle in accordance with the fifth ciphertext, and extracting a seventh ciphertext of coefficients of the second polynomial from the sixth ciphertext, which provides a plaintext of a carry out corresponding to the fifth ciphertext, and
obtaining an eighth ciphertext of a fourth polynomial obtained by making coefficients of a third polynomial cycle in accordance with the fifth ciphertext, and extracting a ninth ciphertext of coefficients of the fourth polynomial from the eighth ciphertext, which provides a plaintext of a sum output corresponding to the fifth ciphertext.

18. The encryption processing apparatus according to claim 17, wherein the error is less than 1/48 of the predetermined value.

19. The encryption processing apparatus according to claim 17, wherein the error is acceptable in an application to which the encryption processing apparatus is applied and is 1/48 or more of the predetermined value, depending on a probability that a different calculation result is obtained.

20. A non-transitory computer-readable recording medium storing an encryption processing program for causing a processor to execute an encryption process of processing a ciphertext,
the ciphertext being a fully homomorphic cyphertext that has as a plaintext either one of two values, the value being obtained by adding an error with a predetermined variance to a value corresponding to a symbol 0 or 1 in a divided region obtained by dividing a value range into a predetermined number, and that is able to be subjected to a logical operation without being decrypted,
the encryption process including
performing a homomorphic operation related to a predetermined operation for three or more ciphertexts, and calculating a new ciphertext by applying a first polynomial to a ciphertext that is a result of the homomorphic operation, wherein
an error range for the three or more ciphertexts is set to make an error added to a plaintext of the ciphertext that is the result of the homomorphic operation fall within a range of a divided region obtained by dividing a value region of the plaintext of the ciphertext that is the result of the homomorphic operation.
